(19) United States
(12) Patent Application Publication
(10) Pub. No.: US 2025/0131447 A1
(43) Pub. Date: Apr. 24, 2025

(54) SYSTEMS AND METHODS FOR CONFIGURABLE AUTHORIZATION EXPIRATION

(71) Applicant: Simnang IP, LLC, Farmington, UT (US)

(72) Inventors: Rhett M. Roberts, Kaysville, UT (US); Sloan A. Smith, West Haven, UT (US)

(21) Appl. No.: 18/491,767

(22) Filed: Oct. 21, 2023

(51) Int. Cl. G06Q 20/40

(52) U.S. Cl. CPC G06Q 20/407; G06Q 20/405

(57) ABSTRACT

Systems and methods for configuring authorization expiration. The disclosed systems and methods receive rule data for defining an expiration for transaction authorizations and receive a transaction authorization request for a transaction. If the transaction authorization request is approved, the disclosed systems and methods can compare the transaction data to the rule data to determine whether a match occurs for the transaction data and the rule data. If there is a match, the disclosed systems and methods can set a transaction authorization expiration to the expiration value. The disclosed systems and methods can transmit the transaction data to a ledger system, which is configured to update an available balance based on the transaction data. If the transaction remains pending to a current time corresponding to the transaction authorization expiration, the disclosed systems and method can effectuate expiration of the transaction authorization, in which case there would further be a transmission of in indication of expiration of the transaction authorization to the ledger system, which is configured to reverse the update to available balance, according to the transaction authorization expiration.

### BACKGROUND

The present disclosure relates generally to the field of authorizing transactions. A complex chain of computers and servers exchanging authorization requests and authorization messages connects a merchant to a customer's bank. When a transaction is authorized, the amount that will ultimately clear (e.g., eventually be spent) is not always known. For example, if a card swipe is made for gas, some amount is authorized, but it's not until the gas is pumped that the final amount is known. When an amount is authorized, there may be an interest or desire that the authorized funds be frozen until the actual amount clears. If no amount ever clears for the authorization, however, difficulties can ensue while the authorized amount remains held and cannot be used until the authorization is expired.

### SUMMARY

Systems and methods are disclosed for configuring expiration for an authorization of a transaction. A creditor (lender) or card issuer may identify one or more attributes of transaction authorizations that should have a desired authorization expiration. One or more rules can be defined for recognizing a transaction authorization request having such attributes. An expiration value can be configured for the transaction authorizations recognized as having such attributes.

### BRIEF DESCRIPTION OF THE DRAWINGS

FIG. 1 is a block diagram illustrating an example environment in which an authorization engine may be used, according to some implementations.

FIG. 2 is a system architecture for authorizing transactions using the authorization engine, according to some implementations.

FIG. 3 is a block diagram of an issuing processor aggregator interface of an issuing processor aggregator, according to some implementations.

FIG. 4 is a flowchart of a method to manage transactions, according to some implementations.

FIG. 5 is a flowchart of a method to configure authorization expiration, according to some implementation.

FIG. 6 is a block diagram illustrating example details of the available credit service, according to some implementations.

FIG. 7 is a block diagram illustrating example details of the electronic ledger, according to some implementations.

FIG. 8 is a block diagram illustrating example details of a comparator, according to some implementations.

FIG. 9 is a flowchart illustrating example operations in a method for approving or denying transactions.

FIG. 10 is a flow diagram depicting transaction management, according to some implementations.

FIG. 11 is a user interface for configuring transaction authorization expiration, according to some implementations.

FIG. 12 illustrates an example computer system.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

Aspects of the present disclosure relate to configuring an expiration of an authorization for a transaction or other exchange. When a transaction is authorized, the amount that will ultimately clear (e.g., eventually be spent) is not always known. For example, if a card swipe is made for gas, some amount is authorized, but it is not until the gas is pumped that the final amount is known. As another example, if a card is used through a webpage to make a hotel reservation, some amount is authorized, but it is not until checkout that the final amount for the stay is known. When an amount is authorized, there may be an interest or desire that the authorized funds be frozen until the actual amount clears. For example, a creditor (lender) may wish to ensure a line of credit is not overdrawn. A deposit bank may desire to ensure a deposit account is not overdrawn. A prepaid card issuer may have a strong interest that prepaid funds are not disbursed twice. However, if no amount ever clears for the authorization—e.g., the gas is never pumped, or the hotel reservation is canceled—the authorized amount may continue to be held and cannot be used until the authorization is expired, and other challenges ensue. If the expiration period is too long, then future authorization requests may be denied (e.g., for insufficient available balance), leading to loss of fees for such transactions and deposit holders. A cardholder may swipe their card and get an unexpected decline due to velocity limits or balance limits that are a result of authorized funds that should have been released, and they end up trusting the card and card brand less. In contrast, if the expiration period is too short, then merchants and/or customers may be unduly inconvenienced by, for example a later denial of a transaction for lack of an affirmative or pending authorization, and/or may simply choose other payment vehicles or modes.

The length or timing of an appropriate expiration period(s) before an authorization should expire will vary based on the scenario. For example, if a gas purchase is authorized, but no amount is cleared within 24 hours, it probably makes sense to expire the authorization. In the case that a hotel room is book, however, 24 hours is probably too short a time to expire the authorization. Determining appropriate timing may improve through trial and error, experimentation, and/or better data tracking for expiration scenarios.

Presently available systems and methods, however, cannot provide configurable expiration periods. Generally, expiration of authorizations is configured or otherwise designated by an issuing processor. Further, in existing systems and methods, expiration of authorizations varies based solely on a merchant category code (MCC). Again, the variation is established, generally by an issuing processor, and once established may not be easily or readily configurable.

The present disclosure provides systems and methods to enable a user (e.g., card issuer, creditor (lender), account holder) to configure (or re-configure) expiration of authorizations. The expiration can be configured in a broad manner to apply to many or all authorizations of a category, type or genre (e.g., for transactions relating to gas or hotel, or transactions occurring in a given country). The expiration can be configured in a more granular manner to apply to authorizations that satisfy multiple attributes (e.g., with a given merchant in a given city or at a given address). More particularly, the present technology allows user to set expiration based on attributes other than the MCC. For example, the present technology allows setting expiration based on MCC, merchant name, merchant descriptor, merchant currency, merchant address, merchant city, merchant state, merchant postal code, merchant country, etc.

The present technology, according to one example, allows a rule to be defined that includes one or more attribute fields and one or more values for each attribute field of the one or more attribute fields. Boolean logic, set logic, or other appropriate operators can be used in combining multiple attribute fields. For example, a first attribute field, “merchant name,” may be used and one or more values (e.g., Marriott®, Hilton®, Hyatt®) may be designated. The rule may also indicate a second attribute field, “merchant country,” may also be used and one or more values (e.g., United States) may be designated. The attribute field-value pairs may be combined with logic operators as follows:

If “merchant name” = “Marriott” OR “Hilton” OR “Hyatt”
AND
If “merchant location” = “United States”

Then set expiration to 30 days.

An authorization engine, according to the present technology, can interface with one or more issuing processors and can monitor transaction authorization requests to detect or otherwise identify given authorization requests that satisfy a rule. The authorization engine, or a comparator engine thereof, may handle monitoring of authorization requests and configuring expiration of the same.

The authorization engine solves various technical problems and provides various technical improvements including conserving computing resources, conserving network resources and providing for faster and more accurate handling of expirations of authorizations for transactions. The present technology conserves computing resources by reducing unnecessary denials of transactions while still accomplishing desired objectives of considering authorized transactions as part of an available balance. An appropriately configured expiration can reduce repeated authorization requests (e.g., due to an expiration period that is too short) and unnecessary authorization denials (e.g., due to an expiration period that is too long), both of which require unnecessary duplicative computation. A user (e.g. card issuer, creditor (lender), and/or account holder) of the authorization engine has both relevant data and the high (e.g., the greatest) incentives to appropriately configure an expiration of authorization requests. If the expiration of and authorization is too short, the user risks losing the associated transaction and/or customer satisfaction and/or loyalty. If the expiration of the authorization request is too long, the user risks losing other future or potential transactions (e.g., due to funds being held and the available balance too low) and customer satisfaction and/or loyalty due to inconvenience of unnecessary denial of authorization requests. Accordingly, the authorization engine enables more efficient operation of a transaction ecosystem by enabling more efficient configuration of expiration of authorization requests. Enabling configuration of authorization expiration, based on more attributes and/or at a more granular level, provides for greater flexibility in more appropriately and efficiently handling expiration of authorization.

The authorization engine conserves network resources as configuration of expirations can be configured and handled at a point where authorization of a transaction request occurs, rather than by providing communications to an issuing processor over a network. Further, by enabling configuration of expirations, unnecessary transaction denials can be averted, thereby reducing demand on network resources. Handling expiration of authorizations at an authorization engine conserves network resources, as the authorization engine can aggregate transaction authorizations from multiple issuing processors and for multiple line of credit engines. In this way, the multiple line of credit engines do not each have to establish separate connections with each of the issuing processors. Instead, each line of credit engine can establish a single connection with the authorization engine and each issuing processor can establish a single connection with the authorization engine. In this way, network resources are conserved, as well as compute resources, as the multiple line of credit engines do not have to determine to which issuing processor authorization information should be sent.

In some implementations, the authorization information may be sent from the line of credit engine to the authorization engine as a single number in a standardized format. In this way, network resources are conserved, and compute resources are conserved, as the authorization engine needs to only compare the single number to incoming transaction data to determine whether to approve or deny the transaction. Providing authorization information as single numbers in a standardized format further enhances the ability of the authorization engine to aggregate multiple line of credit engines and issuing processors, further conserving network and compute resources.

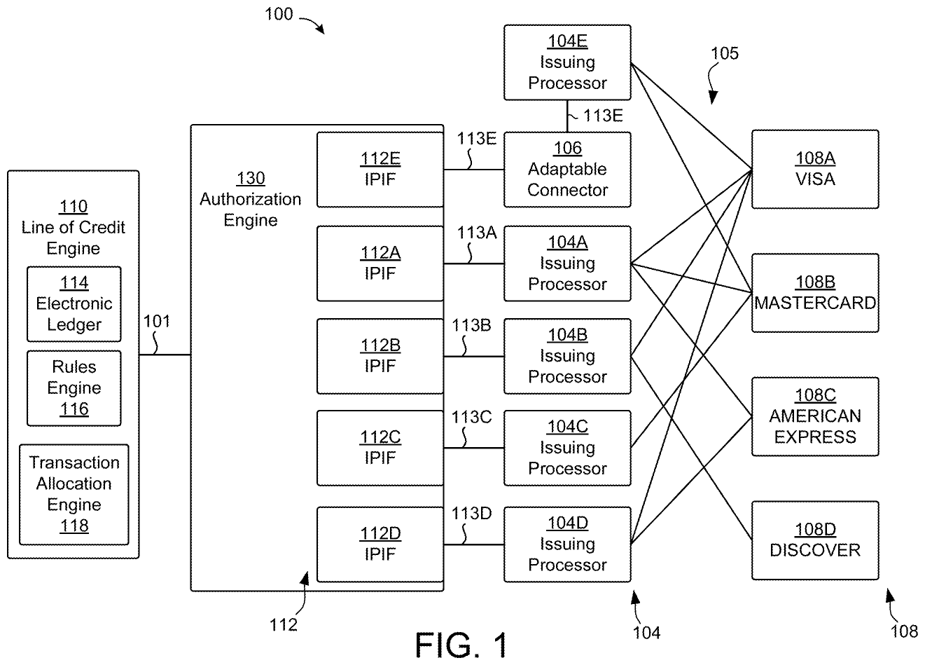

FIG. 1 is a block diagram illustrating an example environment 100 in which an authorization engine 130 may be used, according to some implementations. The authorization engine 130 may receive transaction authorization requests from multiple different issuing processors 104 received from multiple different card networks 108. The authorization engine 130 may use information from a line of credit engine 110 to authorize or deny the transaction authorization requests.

The authorization engine 130 can aggregate interfaces to the issuing processors 104. Issuing processors 104 can, in turn, implement connections to the card networks 108. For example, to implement a card program, information should be exchanged over a connection to an issuing processor 104. However, various issuing processors 104 can include computing systems which include differing data, differing data formats, or differing functions. Thus, it may be difficult for a system to interface between various issuing processors 104. For example, where different issuing processors 104 are connected to different networks, a computing system may interoperate with multiple issuing processors 104, or, incident to a selection of a new issuing processor, a computing system may be migrated between issuing processors 104. However, once integrated with a first issuing processor 104, it may be difficult to migrate to another.

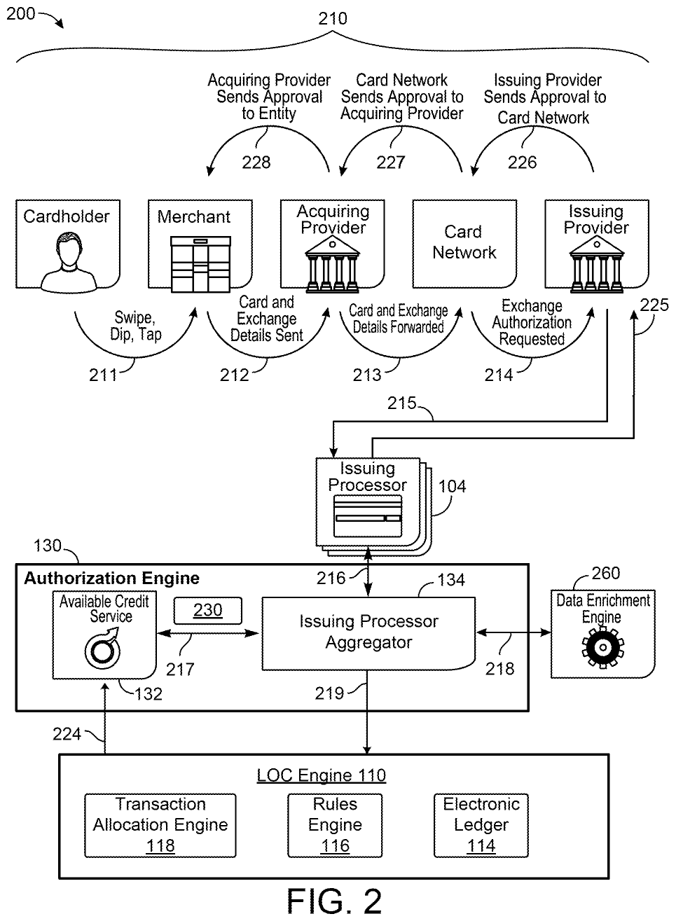

To overcome the aforementioned technical deficiencies, the authorization engine 130 can operate as middleware between a computing system and any number of issuing processors 104. For example, the authorization engine 130 can include various interfaces (e.g., issuing processor integration interfaces (IPIFs) 112, connections, etc.). The interfaces may be or can include API's, push or pull notification systems, data repositories accessible by an issuing processor 104, combinations thereof, or the like. The authorization engine 130 can communicate across the various interfaces by translating data into a format that matches an interface. Such translation can include generating or enriching data, translating information, or performing multiple operations for one issuing processor 104 to match a same functionality as another issuing processor 104, in a manner which is transparent to a computing device (e.g., at a uniform interface 101). For example, the authorization engine 130 can convert various data of an issuer entity to a uniform format (e.g., JSON) that may be transmitted to the line of credit engine 110. The line of credit engine 110 may update an electronic ledger 114 using the data, apply rules to the data using a rules engine 116, and determine an updated available balance to the authorization engine 130 using the transaction allocation engine 118, as discussed in greater detail in conjunction with FIG. 2.

The authorization engine 130 connects to a first issuing processor 104A, second issuing processor 104B, third issuing processor 104C, fourth issuing processor 104D, and fifth issuing processor 104E (collectively, issuing processors 104, also referred to as issuer processors 104, without limiting effect). The various issuing processors 104 can, in turn, connect to various networks referred to collectively as card networks 108. Particularly, the depicted system 100 includes the non-limiting illustrative examples of a VISA® network 108A, MasterCard® network 108B, American Express® network 108C, and Discover® network 108D. Each issuing processor 104 can connect to any number of card networks 108 over a respective connection 105 thereto. For example, as depicted, various issuing processors 104 may connect to at least one of the card networks 108 and/or may omit a connection to one or more card networks 108. In the example of FIG. 2, the authorization engine 130 connects to the fifth issuing processor via an adaptable connector 106, which will be explained more fully below.

An electronic ledger 114 is depicted as constituent to a line of credit engine 110. According to various embodiments, the electronic ledger 114 can couple to various system 100 components. The various components of the line of credit engine 110 and the authorization engine 130 (e.g., the electronic ledger 114, the rules engine 116, and the transaction allocation engine 118, as discussed in FIG. 2) may be associated with a uniform interface 101. However, as indicated above, the various issuing processor connections 113, can vary from each other and from the uniform interface 101. Thus, various issuing processor integration interfaces (IPIF) 112 can intermediate a corresponding issuing processor 104 from the uniform interface 101. The IPIF 112 can adapt, translate, generate, supplement, enrich, or otherwise retrieve information from various sources to adapt an entity (e.g., one or more data structures) between the issuing processor 104 and the uniform interface 101. For example, the adaptation can include a translation for a uniform interface 101 associated with the electronic ledger 114 of FIG. 1.

The uniform interface 101 can include an application programming interface (API) which may be configured to receive data according to a pre-determined format. For example, the uniform interface 101 can arrange information according to JSON, XML, or other format. The authorization engine 130 can exchange information with the uniform interface 101 (e.g., receive from, or convey to). For example, the authorization engine 130 can retrieve data of an issuer entity from other connections including other APIs, FTP sites, or other repositories, push notification, emails, or other data conveyance paths and adapt said data to the uniform interface.

In some implementations, multiple line of credit engines may connect to the authorization engine 130. In an example, multiple lenders may send available balances associated with customer accounts to the authorization engine 130 for the authorization or denial of transactions. In some implementations, the authorization engine 130 may include multiple separate instances, such that each line of credit engine connects to a corresponding instance of the authorization engine 130. In this way, each respective line of credit engine may send balance information to a corresponding authorization engine 130 which is specific to the respective line of credit engine and which includes balance information of only the respective line of credit engine.

The authorization engine 130 couples to the various issuing processors 104 via respective connections. For example, various connections shown as direct connections, such as a first connection 113A between the first issuing processor 104A and the first IPIF 112A can include a logically direct connection (e.g., an issuer entity portion conveyed by the first IPIF 112A may be the same as is received by the issuing processors 104). Such connections can include various intermediary devices such as switches, routers, cables, or so forth, which can include appendages or concatenations of various checksums, framing or packetizing padding or data, or so forth. As depicted, a second connection 113B between a second IPIF 112B and a second issuing processor 104B; third connection 113C between a third IPIF 112C and a third issuing processor 104C; or fourth connection 113D between a fourth IPIF 112D and a fourth issuing processor 104D can likewise interface without logical intermediation. The various IPIF 112A, 112B, 112C, 112D, 112E may be referred to, collectively, as IPIF 112.

According to some embodiments of the present disclosure, the authorization engine 130 may enable configuring expiration for an authorization of a transaction. A user (e.g., creditor (lender), card issuer, account holder, etc.) may identify one or more attributes of transaction authorizations that should have a desired authorization expiration. One or more rules can be defined for recognizing a transaction authorization request having such attributes. An expiration value can be configured for the transaction authorizations recognized as having such attributes. The authorization engine 130 may handle monitoring and messaging for expiration of an authorization.

According to the present disclosure, the authorization engine 130 can implement one or more interfaces to couple to any number of issuing processors. One or more interfaces generated by the authorization engine 130 may be configured to couple to an adaptable connector 106 to connect to the issuing processor 104. For example, the adaptable connector 106 can implement any of the translations (e.g., generations) discussed herein. That is, the adaptable connector 106 may be adaptable to a previously generated interface, and may further provide a connector for a uniform interface 101. For example, the adaptable connector 106 can implement a data enrichment operation, such as by comparing a predefined list of merchants to a location, MCC, or other issuer entity.

In some embodiments, the adaptable connector 106 may be or include an application operating on an external computing device from the authorization engine 130. The adaptable connector 106 can operate as middleware between the authorization engine 130 and the issuing processor 104E. In doing so, the adaptable connector 106 can transfer data between the issuing processor 104 and the authorization engine 130 (e.g., through the IPIF 112E), in some cases without any modification. Such may be advantageous, for example, when systems connect with the authorization engine 130 that already are connected to an issuing processor. Such systems can operate to route communication between the authorization engine 130 and the issuing processor to perform different functions, such as to complete transactions.

As depicted, and in some embodiments, the adaptable connector 106 intermediates a fifth connection 113E between the fifth IPIF 112E and a fifth issuing processor 104E. The adaptable connector 106 can perform any of the operations of the various IPIF 112. For example, the adaptable connector 106 can perform a first portion of enrichment operations for translations between the various transactions and the uniform interface 101, and the fifth IPIF 112E can perform any additional or further operations. For example, the authorization engine 130 can lack a connection 113 to directly interface with the fifth issuing processor 104E, and a merchant can include a pre-defined interface to couple to an issuing processor 104. The pre-defined interface can include various connectors to data enrichment tables, servers, or other data sources for an issuer entity such that including a connection to the adaptable connector 106 can provide a translator to the uniform interface with obviates at least some operations of architecting an IPIF 112E to couple directly to the fifth issuing processor 104E (e.g., defining or consolidating data sources to generate instances of the issuer entity which are mappable or translatable to the uniform interface).

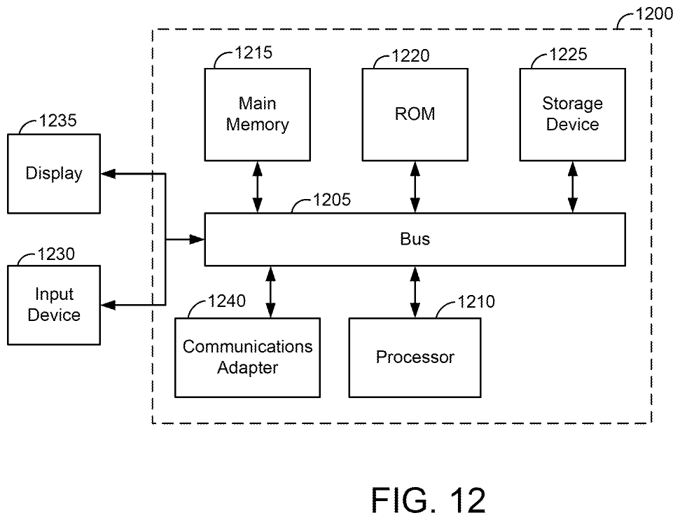

Each system or device in the computing environment may include one or more processors, memories, network interfaces (sometimes referred to herein as a “network circuit”) and user interfaces. The memory may store programming logic that, when executed by the processor, controls the operation of the corresponding computing system or device. The memory may also store data in databases. For example, the system 100, or the various components thereof can include one or more components or structures of functionality of computing devices depicted in FIG. 12. The network interfaces may allow the computing systems and devices to communicate wirelessly or otherwise, e.g., via a network. The various components of devices in the computing environment may be implemented via hardware (e.g., circuitry), software (e.g., executable code), or any combination thereof. Systems, devices, and components in FIG. 1 may be added, deleted, integrated, separated, and/or rearranged in various embodiments of the disclosure.

FIG. 2 is a system architecture 200 for authorizing transactions using the authorization engine 130, according to some implementations. The system architecture 200 depicts the process of a cardholder performing a transaction and the components of an authorization engine 130 (in particular, an issuing processor aggregator 134 and an available credit service 132) receiving transaction data from a provider for processing the transaction. An illustrated computing environment 210 depicts the process of exchanging information between the cardholder, merchant, providers and card networks 108. For example, at 211 the user can perform a swipe action (e.g., dip, tap or otherwise provide card information to a merchant), such as by interfacing a physical card or mobile wallet with a point of sale (POS) terminal. At 212, the card and transaction details (or data) may be sent to an acquiring provider (e.g., acquiring financial institution (FI)). At 213, the acquiring provider can forward the card information (or other requital form) and transaction details to a card network 108, and at 214 the card network 108 can request, from an issuing provider, a transaction authorization (e.g., authorizing the transaction). A “card” can refer to or correspond to an account corresponding to one or more ledgers, or a physical or virtual token associated therewith. For example, a card can correspond to a physical credit, debit, or other stored value account. The card may correspond to a virtual card of a mobile wallet, or other stored value account. A card can refer to a token used according to a physical presence of a token (e.g., mobile wallet or credit card). A card can refer to another operative connection, such as a token (e.g., account number, virtual account number, or other information) provided via a wired or wireless network. A card can refer to a reference to pre-communicated information, such as an indication to process a transaction based on previously converted credentials (e.g., a saved payment card).

It will be understood that the actions 215-225 described herein may be executed by the authorization engine 130 (and components thereof) and devices connected thereto, in particular, issuing processors 104, a data enrichment engine 260 and an available credit service 132. The authorization engine 130 may include the issuing processor aggregator 134 and the available credit service 132. In some implementations, the authorization engine 130 may include the data enrichment engine 260. In some implementations, the issuing processor aggregator 134 includes the available credit service 132. In some implementations, the authorization engine 130 is part of the line of credit engine 110. In some implementations, the authorization engine 130 is separate from the line of credit engine 110 and transmits information to and receives information from multiple line of credit engines. The available credit service 132 can include multiple entries of available balances from the electronic ledger 114 of the line of credit engine 110. The available credit service 132 can include multiple entries of available balances from multiple electronic ledgers of the multiple line of credit engines.

The authorization engine 130 may approve or deny the transaction. The authorization engine 130 may approve or deny the transaction in response to the transaction authorization request. In some embodiments, the authorization engine 130 may include or otherwise utilize a comparator 230 to compare transaction data (e.g., an amount) against an available balance. In some embodiments, the comparator 230 of the authorization engine 130 may approve or deny the transaction based on information from the available credit service 132. In some implementations, the issuing processor aggregator 134 may approve or deny the transaction based on information from the available credit service 132. At 215, the issuing provider can provide to the issuing processor 104 transaction data of a transaction. In some implementations, at 215, the issuing processor 104 can query the issuing provider on a periodic basis for new changes. At 216, the transaction and transaction data may be encrypted and/or a secure communication channel (e.g., secure socket layer (SSL), transport layer security (TLS), etc.) may be established between the issuing processor 104 and the issuing processor aggregator 134. At 216, issuer data (e.g., data fields, data structures, information disposed within computer-readable instructions, or other information associated with card creation, administrative functions, or transaction management) may be exchanged over a connection between the issuing processor 104 and the issuing processor aggregator 134. The issuer data may be exchanged according to one or more messages over one or more communications channels, such as an encrypted channel, as provided above. The messages may be provided as point to point messages, or by a provision of any number of data fields of the issuer data to a shared resource (e.g., a shared memory, a mutually accessible server location, or another data repository).

At 217, the issuing processor aggregator 134 can obtain a real-time available balance associated with an account of the cardholder from the available credit service 132. The issuing processor aggregator 134 may compare the transaction data to the real-time available balance to authorize or deny the transaction. The real-time available balance may include various parameters associated with the account of the cardholder. In an example, a transaction exceeding the real-time available balance, a transaction limit, daily spend limit, MCC category limit, or located in a restricted area may be indicative of a denial. The issuing processor aggregator 134 may authorize or deny the transaction based on the comparison of the transaction data to the real-time available balance. In an example, if a transaction amount of the transaction is less than the real-time available balance, the transaction may be approved. In an example, if a transaction amount of the transaction is greater than the real-time available balance, the transaction may be denied. The issuing processor aggregator may, upon determining whether the approve or deny the transaction, send an authorization message or denial message to the issuing processor. In some implementations, the issuing processor aggregator 134 sends the authorization message or denial message to the issuing processor 104 immediately upon determining whether to approve or deny the transaction. In this way, the issuing processor aggregator 134 may approve or deny the transaction within a time period required for the transaction approval.

Alternatively or in addition, in some embodiments, at 217 the issuing processor aggregator 134 can provide transaction data to the available credit service 132. The available credit service 132 may compare the transaction data to the real-time available balance to authorize or deny the transaction. The available credit service 132 may authorize or deny the transaction based on the comparison of the transaction data to the real-time available balance. In some embodiments, at 217, both the available credit service 132 and the issuing processor aggregator 134 provide information to the authorization engine 130, which may compare the transaction data to the real-time available balance to authorize or deny the transaction. In some embodiments, the authorization engine 130 may include a comparator 230 to compare the transaction data to the real-time available balance to authorize or deny the transaction.

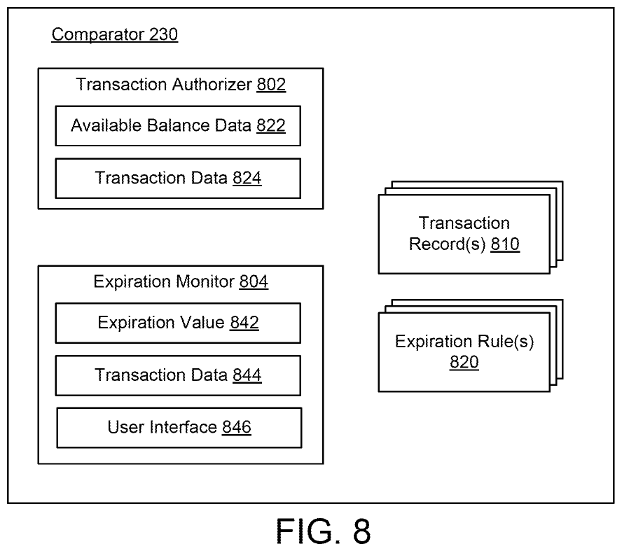

At 217, the authorization engine 130 can also determine an expiration value for the authorization of the transaction. In some embodiments, the issuing processor aggregator 134 of the authorization engine 130 may determine the expiration value for an authorization. In some embodiments, the available credit service 132 of the authorization engine 130 may determine the expiration for an authorization. In some embodiments, a comparator 230 may be utilized. The authorization engine 130, the available credit service 132, and/or the issuing processor aggregator 134 may include or otherwise utilize a comparator 230. Stated otherwise, in different embodiments, a comparator 230 may be a distinct component or a subcomponent integrated into another component of the authorization engine 130. An example embodiment of a comparator 230 is discussed more fully below with reference to FIG. 8.

The authorization engine 130 can compare transaction data to rule data to determine an expiration value to be assigned or otherwise established for a transaction. The rule data can include one or more rules. Each rule includes an expiration value and one or more attribute field-value pairs that specify an attribute type and a corresponding value, which, if met by a transaction, designate the transaction to have the expiration value. In other words, the attribute-field value pairs provide the attributes for transactions that are to expire according to the expiration value. The attribute field-value pairs provide criteria for identifying applicable transactions. The expiration value can be a point in time, a date, a duration, a period, or any other suitable value for indicating a point at which expiration for authorization of the transaction is to occur. The attribute-field-value pairs may each comprise an attribute field and a set of one or more values that correspond to the attribute field. For example, an attribute field may be “merchant name” and the set of values may be “Marriott®”, “Hilton®”, and “Hyatt®”. The rule may also indicate a second attribute field, “merchant country,” and the set of one or more values may include “United States.” The attribute field may be any attribute of a transaction. Examples of attribute fields (and attributes of transactions) include, but are not limited to: merchant category code, merchant name, merchant descriptor, merchant currency, merchant address, merchant city, merchant state, merchant postal code, and merchant country. A rule can also include Boolean logic, set logic, or other appropriate operators, which can be used in combining multiple attribute fields. For example, the attribute field-value pairs may be combined with logic operators as follows:

If “merchant name” = “Marriott” OR “Hilton” OR “Hyatt”
AND
If “merchant location” = “United States”
Then transaction expiration = expiration value (e.g., 30 days).

The authorization engine 130 can compare transaction data to the rule data to determine if the transaction meets (or satisfies) the criteria of any rules of the rule data. Comparing the transaction data to the rule data can include comparing each value of the set of one or more values of the one or more attribute fields to corresponding attribute data of the transaction data to determine whether a match occurs. The authorization engine 130 can compare the merchant name for the transaction against the set of values of the attribute fields of the rules of the rule data. If there is a match to a rule of the rule data, the authorization engine 130 can set an expiration of the transaction to the expiration value of that rule. The authorization engine 130 may define an expiration field of a transaction record to be equal to the expiration value of the rule. The record can then be monitored or regularly checked to determine if the transaction status remains uncleared (e.g., pending, approved) and if a current time corresponds to the expiration value. When the current time does correspond to the expiration value (e.g., the expiration value has been met or exceeded), the authorization engine 130 can set the status of the transaction record to “voided” or “expired” and communicate the expiration to the issuing processor 104 and/or the LOC engine 110.

At 218, the transaction data can be augmented or enriched with additional data (or supplemental data) from a data enrichment engine (or source, partner) 260. The additional data may, for example, provide additional information about a merchant or other participant to a transaction. The additional information can enable additional searching, sorting, routing, etc. of a transaction according to additional features or attributes. Additionally or alternatively, at 218, the transaction data may be sent (e.g., securely) to a data enrichment engine 260. The data enrichment engine 260 may scrub and/or clean (e.g., fixing incorrect, incomplete, duplicate or otherwise erroneous data in the data set, detecting and correcting corrupt or inaccurate records from a record set, table, or database and by incomplete, incorrect, inaccurate, or irrelevant parts of the data and then replacing, modifying, or deleting the dirty or coarse data). The data enrichment engine 260 may analyze and/or supplement the transaction data to obtain enriched transaction data. In an example, the data enrichment engine 260 determines a spending category for the transaction based on the transaction data. In some implementations, the data enrichment engine 260 is part of the issuing processor aggregator 134. In some implementations, the data enrichment engine 260 is part of a separate, third-party service. In an example, the data enrichment engine 260 may be executed on or hosted on a server separate from a server on which the issuing processor aggregator 134 is executed or hosted.

In some implementations, the issuing processor aggregator 134 queries the available credit service 132 for the real-time available balance at 217 and sends the transaction data to the data enrichment engine 260 at 218 in parallel. The issuing processor aggregator 134 may compare the transaction data to the real-time available balance to approve or deny the transaction independent of obtaining the enriched transaction data from the data enrichment engine 260. In this way, there is no delay in approving or denying the transaction due to the data enrichment engine 260.

At 219, the transaction data and/or the enriched transaction data may be posted or sent to the line of credit engine 110. The line of credit engine 110 can perform any number of operations based on the receipt of the transaction data, such as adjustment or appendage to the electronic ledger 114. For example, the line of credit engine 110 can adjust an available balance, number of transactions per day, transaction history, or other information. The line of credit engine 110 may apply pending transactions, fees, interest, payments, and other calculations to the electronic ledger 114 to obtain the real-time available balance. The real-time available balance may represent a real-time, accurate representation of the available balance, taking into account all factors that affect the available balance, such as pending transactions, fees, interest, payments, and other calculations. The real-time available balance may differ from an estimated available balance calculated by tracking transactions and payments. Conventional systems may rely upon estimated available balances calculated at the issuing processor 104. Use of the real-time available balance provides for more accurate authorization or denials of transactions while reducing a computing load at the issuing processor 104 and/or the authorization engine.

The line of credit engine 110 may transmit, at 224, the real-time available balance to the available credit service 132. The available credit service 132 may store the real-time available balance for comparison with transactions, as discussed herein. The issuing processor aggregator 134 may query the available credit service 132 to compare a current transaction to the real-time available balance. The real-time available balance stored at the available credit service 132 may be updated in response to each transaction. In an example, once a transaction is approved, the issuing processor aggregator 134 sends the transaction data to the line of credit engine 110 which updates the real-time available balance and transmits the updated real-time available balance to the available credit service 132.

In some implementations, the line of credit engine 110 generates at 224, the information associated with the transaction data by processing the transaction data using the rules engine 116. The rules engine 116 may apply one or more rules to the transaction data to determine one or more categories or buckets associated with the transaction. In an example, the rules engine 116 may determine, based on the transaction data, that the transaction is a vehicle maintenance purchase. In an example, the rules engine 116 may determine, based on the transaction data, that the transaction is a reimbursable purchase. In an example, the rules engine 116 may determine, based on the transaction data, that the transaction is a business purchase. In an example, the rules engine 116 may determine that the transaction is a tax-deductible purchase.

The transaction allocation engine 118 may allocate the transaction to one or more categories or buckets based on the determinations of the rules engine 116. The transaction allocation engine 118 may select one or more of the determined categories or buckets determined by the rules engine 116. In an example, the rules engine 116 may determine that the transaction belongs to two buckets and the transaction engine 118 may allocate the transaction to one of the buckets, both of the buckets, or split the transaction between the two buckets. In an example, the rules engine 116 may determine a first probability that the transaction belongs to a first bucket and a second, higher probability that the transaction belongs to a second bucket, and the transaction engine 118 allocates the transaction to the second bucket. In some implementations, the transaction engine 118 may allocate the transaction to the one or more categories or buckets by updating the electronic ledger 114. In some implementations, the transaction engine 118 may allocate the transaction to the one or more categories or buckets by updating a bucket ledger.

At 225, the issuing provider may be provided a response. The response may include an approval message. The response may include a denial message. At 226, the issuing provider sends an approval to the card network. At 227, the card network can send an approval to the acquiring provider. At 228, the acquiring provider can send the approval to the merchant. The various approvals may or may not include the approval message sent by the issuing processor 104. In an example, once the merchant receives the approval, the merchant completes the transaction by delivering goods or services to the cardholder.

The receipt of the approval, by the merchant, may be received prior to an expiration of a predefined time. For example, the merchant can include a timeout such that the merchant can locally deny a transaction upon the predefined time (e.g., five seconds) elapsing. Such a technique can improve operational security, such as to reduce a time used by a man-in-the-middle attack which may incur further delay. However, the various operations can include operations across a network which are not generally completed prior to the elapsing of the predefined time. For example, the issuing processor aggregator 134 can gather data from various data sources associated with an issuer entity and convey the issuer entity to the line of credit engine 110 over a uniform interface. The uniform interface may be configured to reduce a number of operations performed by the line of credit engine 110, such as by providing the issuer entity according to a same data structure (e.g., an electronic data structure) as the electronic ledger. That is, the conveyance of information at 219 can include a conveyance of information over a uniform interface. Such a retrieval of disaggregated system and provision of data corresponding to the electronic ledger 114 of the line of credit engine 110 can reduce latency of communication, such that the transaction can process prior to an expiration of the transaction at the merchant POS. In addition, use of the real-time available balance may result in faster, more accurate determinations of approval or denial relative to conventional systems, as discussed herein.

The available credit service 132, the issuing processor aggregator 134, and the comparator 230 can each include one or more processing units, circuitry, or other logic device such as programmable logic array engine, or module, can be implemented in software and/or hardware, and can be separate components or a single component of an authorization engine 130. Similarly, the authorization engine 130 include one or more processing units, circuitry, or other logic device such as programmable logic array engine, or module and can be implemented in software and/or hardware. The rules engine 116 and the transaction allocation engine 118 can each include one or more processing units, circuitry, or other logic device such as programmable logic array engine, or module, can be implemented in software and/or hardware, and can be separate components or a single component of a LOC engine 110. Similarly, the LOC engine 110 include one or more processing units, circuitry, or other logic device such as programmable logic array engine, or module and can be implemented in software and/or hardware.

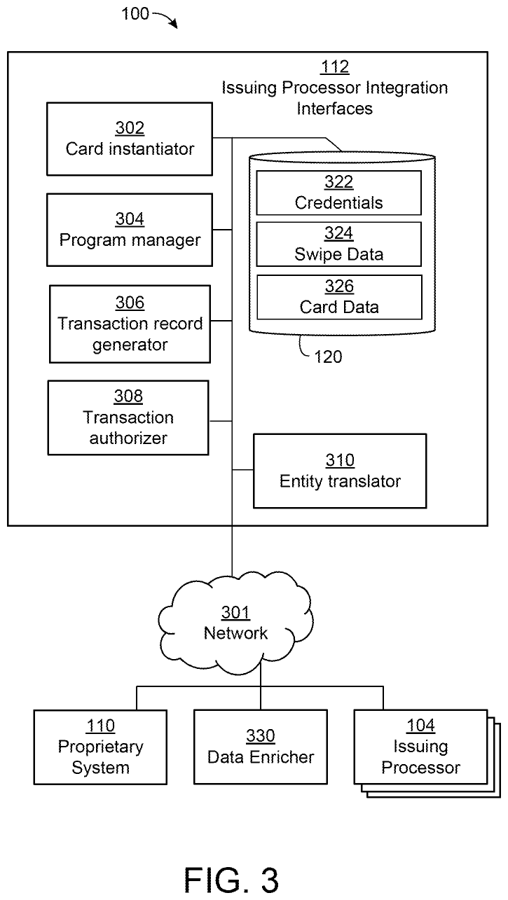

FIG. 3 is a block diagram of an issuing processor aggregator interface (IPIF) 112 of an issuing processor aggregator 102, according to some implementations. The IPIF 112 can include or interface with at least one card instantiator 302. The IPIF 112 can include or interface with at least one program manager 304. The IPIF 112 can include or interface with at least one transaction record generator 306. The IPIF 112 can include or interface with at least one transaction authorizer 308. The IPIF 112 can include or interface with at least one entity translator 310. The card instantiator 302, program manager 304, transaction record generator 306, transaction authorizer 308, or entity translator 310 can each include at least one processing unit or other logic device such as programmable logic array engine, or module configured to communicate with a data repository 320 or database. The card instantiator 302, program manager 304, transaction record generator 306, transaction authorizer 308, or entity translator 310 can be separate components, a single component, or part of the issuing processor aggregator 102, and can include or interface with, or be components of, the system 100 of FIG. 1. The IPIF 112 or can include hardware elements, such as one or more processors, logic devices, or circuits. For example, the IPIF 112, like other components of the system 100 of FIG. 1, can include one or more components or structures of functionality of computing devices depicted in FIG. 12.

The various components of the IPIF 112 can be in network communication via a Peripheral Component Interconnect Express (PCIe) network 301, Ethernet network 301, wireless fidelity (Wi-Fi) network 301, combinations thereof, or the like, including any number of other wired or wireless networks 301. Moreover, the network 301 can interface with various other components such as a cloud based portion of a data repository 320. The network 301 can include computer networks such as the Internet, local, wide, metro, or other area networks, intranets, cellular networks, satellite networks, and other communication networks such as Bluetooth, or data mobile telephone networks. The network 301 can be public or private. The various elements of the system 100 can communicate over the network 301.

The data repository 320 can include one or more local or distributed databases, and can include a database management system. For example, the data repository 320 can include credentials 322, swipe data 324, or card data 326 (e.g., card records).

A credential 322 may refer to or include a token, user name/password combination, or other indication of authentication or authorization. For example, the credentials 322 can be associated with a card program corresponding to one or more cards, wherein a representation of an electronic ledger 114 or information associated therewith (e.g., any other information of the data repository 320 or otherwise accessible to the issuing processor aggregator 102). Credentials can vary according to an access. For example, a cardholder credential can be provided to cause a display of a card associated with the cardholder. A program credential can be provided to cause a display of card data 326 associated with any cards associated with a program.

Swipe data 324 can refer to or include information provided incident to an exchange (e.g., a transaction). For example, the swipe data 324 can include an account number, account holder, merchant identifier, merchant category code (MCC), transaction amount or authorization type (e.g., authorization, pre-authorization, adjustment, release, etc.). The swipe data can include an indication of card presence or absence (e.g., an online or in-person order). The swipe data 324 can include information received from a merchant or information received from another source. For example, the swipe data can include a first data structure originating at a merchant POS, based on an interaction with a mobile wallet, and second information from the mobile wallet (e.g., a location, authentication type, token, or so forth). The swipe data 324 can further include subsequent data structures related to an initial provision of card information. For example, further information can include a cancelation, a release of a hold, or an adjustment (e.g., indication of a tip, or an transaction which is for a different amount that an initial authorization, as in the case of a fuel purchase).

The swipe data 324 can include the data structure received from a device proximal to the transaction (e.g., the POS or mobile wallet) or other data structures or fields substituted for, modified by, or appended to such data structures, such as data fields provided by the acquiring provider, card other exchange network, issuing provider, or issuing processors. For example, various identifiers, risks, timestamps, etc., may be referred to as swipe data, when associated with a card swipe action.

Card data 326 (also referred to as card information, without limiting effect) may refer to or include information assisted with a card. For example, the card data 326 can include any information associated with a cardholder, which may be referred to as a card holder field (e.g., home address, billing address, unique identifier, personal identification number). The card data 326 may refer to or include information associated with an account. For example, the account can include account credentials, numbers, cycle information, ledgers (e.g., a balance of a stored value card, available credit of a credit card, a cash advance value, etc.). The account information can include limits associated with a daily spend, daily withdrawal, MCC spend, number of transactions per time period, or the like.

In some embodiments, the card data 326 can be defined according to a card program. For example, all cards associated with a merchant, organization, bank, or other card program can include one or more data fields defined according to the program. For example, a card program for an association of homebuilders may be associated with no daily spend limit at a construction related MCC. Another card program for cardholders building credit may be associated with a daily spend limit. The association between a data field and a card program can be persistent or a default. For example, in some embodiments, the data field based on the program can be edited according to a request. For example, a cardholder of a card associated with a geographical restriction can request a temporary or permanent removal of the restriction incident to planned travel. The card data 326 may be stored in a nested data structure, such as nested account corresponding to one or more accounts of a user, each account corresponding to one or more transactions. The data structure can be or be similar to a data structure of the electronic ledger 114 of the proprietary system 110. For example, the card data 326 or other data of the data repository 120 can be duplicative of data stored at the proprietary system 110, can be received therefrom, or can reside thereon.

Card data 326 can include card attributes, which can refer to attributes of a card associated with a nested data structure of an electronic ledger 114. A card attribute can include information received from or provided to the electronic ledger 114. For example, a card creation request can include card attributes such as a requested BIN range, cardholder name, cardholder address, card type, card status, credit limit, or cardholder agreement terms. Upon card creation, further card attributes may be associated with the card such as a card number, card verification code (CVC), expiration date, cardholder rewards, etc.

The card instantiator 302 can cause cards to be generated. The card instantiator can receive an indication of a cardholder for the card, such as a name, identifier, or linkage to a user included in an existing data structure. In some instances, (e.g., a new cardholder), the card instantiator 302 can receive card holder fields to generate a new entry for the cardholder. The cardholder fields can be compared to one or more existing cardholders. For example, the card instantiator 302 can determine a merger or two cardholders based on a same address, unique identifier (e.g., social security number, phone number, or email address). The card instantiator 302 can determine that card holder fields do not correspond to an existing cardholder, and generate a new entry for a cardholder based on the determination.

The card instantiator 302 can identify one or more data fields of a uniform interface 101 associated with a cardholder. The card instantiator 302 can provide one or more cardholder fields to the entity translator 310. For example, the card instantiator 302 can provide cardholder fields including a cellular telephone, work telephone, or home telephone field. The entity translator 310 can return a value of a primary phone and secondary phone, or daytime phone and evening phone. The card instantiator 302 can provide one or more data fields to a data enricher 330 of, or interfacing with the system of FIG. 1 (e.g., the data enrichment source 260 depicted in FIG. 2). For example, the card instantiator 302 can provide an address to the data enricher 330, and receive an enriched address. The enriched address can include further fields, such as to a ZIP+4 code generated from address, can include changes to an address, such as to correct “123 Main Av.” to “123 MAIN AVE” according to a desired format. The enriched address can generate a street address based on other location information, such as a latitude and longitude, or otherwise enrich received information.

The enriched card holder fields can correspond to one or more interfaces, such as a uniform interface 101 or one or more issuing processor connections 113. For example, the phone fields, discussed above, can be received as cellular telephone, work telephone, home telephone and home telephone fields. The uniform interface 101 can include primary phone and secondary phone fields, and the issuing processor connection 113 can include a daytime phone and evening phone field. The IPIF 112 can map one or more fields between the respective interfaces. Such mapping can be dynamic or static. For example, the IPIF 112 can receive an indication of a time, compare the time to a predefined threshold, and determine, based on the time, whether the daytime phone should map to a primary or secondary number. Thusly, the card instantiator 302 can generate data fields corresponding to one or more interfaces. Thus, information received can be configured for provision to the uniform interface 101 or the various issuing processor connections 113.

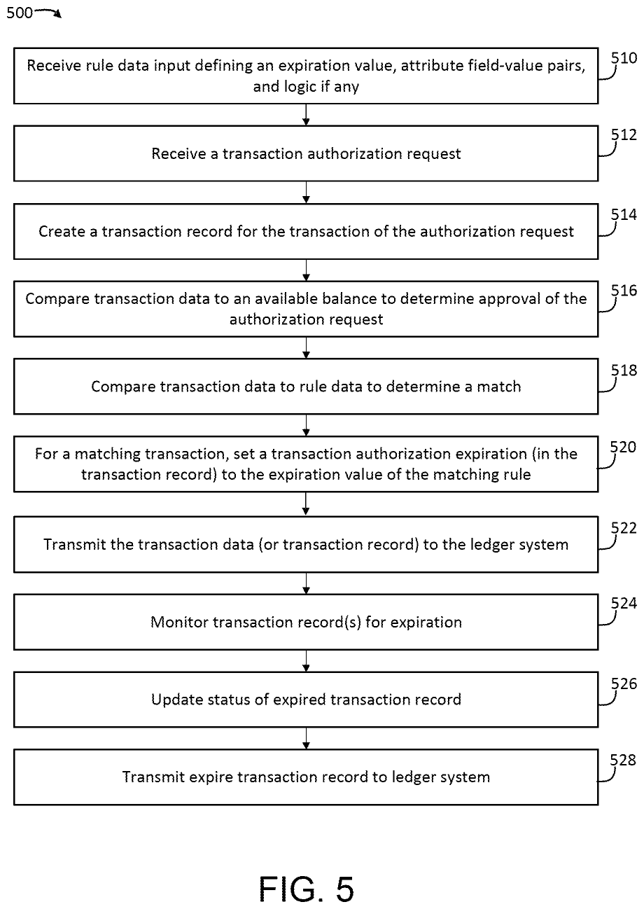

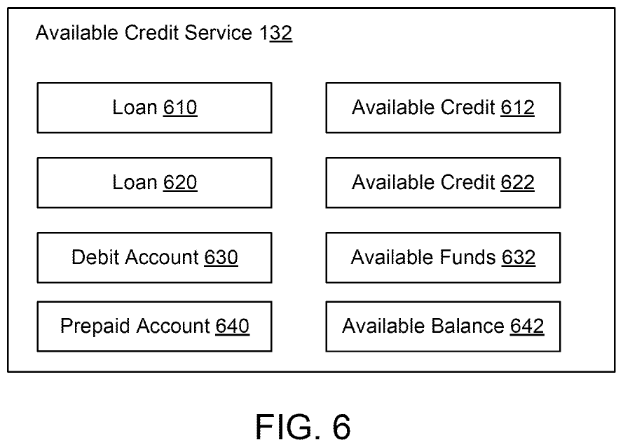

The card instantiator 302 can receive information associated with the card from the proprietary system 110, the information corresponding to the uniform interface, and provide the information to the issuing processor 104 in accordance with an issuing processor connection 113 (e.g., a card creation request). The card instantiator 302 can receive card information from the issuing provider responsive to the card creation request. The card instantiator 302 can provide further information to the proprietary system 110 responsive to the receipt of the card information. Example flows are provided hereinafter, at FIGS. 5 and 6.

The card instantiator 302 can receive a selection of a card program for one or more cards. For example, the selection of the card program can correspond to one or more predefined data fields associated with an account. The card instantiator 302 can include or interface with card data 326 associated with the program. For example, the card instantiator 302 can interface with card data 326 of the data repository 320, or with the program manager 304 to associate a card program with a card. In some instances, card data 326 can be specific to a card. That is, the card program can be a card-specific card program. References, herein, to program data can refer to either programs associated with one card, many cards, or zero cards (e.g., programs which are generated prior to a first card creation). In some embodiments, the card program can correlate to a particular issuing processor 104.

The program manager 304 can manage a card program associated with any number of cards or cardholders. For example, the program manager 304 can receive one more data fields associated with a card program. The program manager 304 can adjust one or more data fields associated with a program or with an account. For example, some data fields can retain a setting corresponding to a card program at a time of creation. For example, a card program can correspond to a bank identification number (BIN) range associated therewith, wherein a change to a BIN or a program may not change a BIN of issued cards. In some instances or implementations, a data field associated with a card field can change, such as to replace all or some existing accounts (e.g., a change to a geographic or MCC restriction can propagate to some legacy accounts which do not include the restriction, but may not propagate to other legacy accounts which include a geographic or MCC restriction exception).

In some instances or implementations, the program manager 304 can manage data fields associated with a physical card, or a depiction of a virtual card. The data fields, or other information or communications associated with the program can be referred to collectively, as a program entity. For example, a card program associated with an athletic franchise, retailer, or credit union can include an associated color, logo, or other card design. The program manager 304 can store a record of a card design corresponding to a program for one or more cards, and provide such a design to one or more user interfaces, such that a user of the user interface can verify a card identity. For example, a presentation of a physical depiction of a card can aid a cardholder in ensuring a selection of an intended card, relative to a presentation of a last 4 account digits, issuing provider, or other card data which may be less familiar to some users.

The transaction record generator 306 can generate a transaction record (e.g., a file, document, table, listing, message, notification, etc.) responsive to a swipe action. For example, upon a receipt of swipe data 324 or other transaction data (e.g., operation 215 of FIG. 2), the transaction record generator 306 can parse the transaction data for one or more predefined fields (e.g., a transaction amount, transaction time, or category code such as an MCC). The transaction record generator 306 can generate a transaction record based on the parsed data. The transaction record can include one or more fields corresponding to the uniform interface 101. For example, the transaction record can include an authorization or transaction amount configured for provision to the proprietary system 110.

The transaction record generator 306 can maintain transaction records based on a receipt of additional swipe data. For example, the transaction record generator 306 can append or substitute transaction record data fields, as in the case of a transaction processing subsequent to a hold, or an adjustment, credit, cancellation, or other action subsequent to a generation of a transaction record. The transaction record generator 306 can generate any portion of the transaction record for provision to another device over the uniform interface 101, or one of the issuing processor connections 113. For example, the transaction record generator 306 can interface with the entity translator 310 to generate multiple (e.g., duplicative) data fields corresponding to a same element parsed from the transaction data. Such duplicative data fields may reduce latency of communication with one or more interfaces. The transaction record generator 306 can interface with the entity translator 310 to generate translations incident to provision or receipt of various messages, which may reduce memory used by the transaction record generator 306, according to some embodiments.

The transaction record generator 306 can append or provide authorization information to a transaction record, such as to record an authorization approval, denial, reason code, or other information. The transaction record generator 306 can append or provide settlement information associated with clearing a transaction. For example, the transaction record generator 306 can interface with the transaction authorizer 308 to provide various transaction record authorization or settlement data.

The transaction record generator 306 can receive a dispute resolution entity such as one or more fields including information associated with a cardholder dispute of a transaction. Wherein some issuer entities of the various IPIF 112 include predefined fields associated with a dispute, the transaction record generator 306 can automatically adjust ledger information based on one or more fields of a dispute resolution entity. For example, a temporary adjustment to a balance, cancelation of a card, or other action can be performed. The transaction record generator 306 can append a transaction record information associated with a dispute, wherein the entity translator 310 can propagate data fields according to various formats, such as APIs, notifications, emails, data stored at a shared resource, etc. responsive to a receipt of the dispute resolution entity. For example, the propagation can be based on an identity of the issuing processor and the data field, as received across the uniform interface 101 from the proprietary system 110.

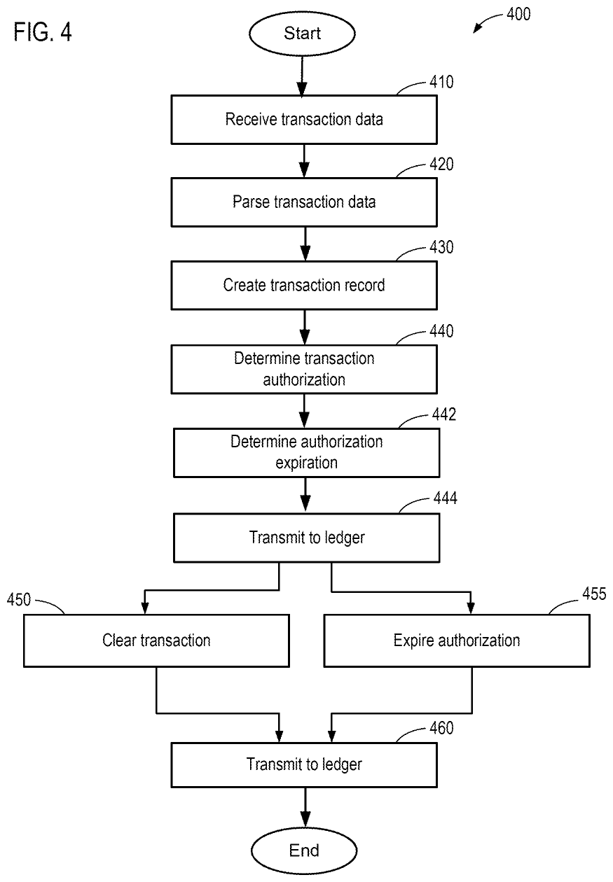

The transaction authorizer 308 can determine an authorization for a transaction. For example, the transaction authorizer 308 can interface with the proprietary system 110 (e.g., an electronic ledger 114 thereof, to determine an account balance) and an issuing processor 104 to authorize and clear a transaction. In some embodiments, the transaction authorizer 308 can also determine an expiration value for the authorization of the transaction. Example of transaction authorization and expiration for the authorization are provided, hereinafter, with reference to FIGS. 4 and 5.

The entity translator 310 can translate data fields associated with an issuer entity between a first instance configured for operation with the uniform interface 101 and one or more further instances configured for operation with respective issuing processor connections 113 of the system 100. For example, the various issuing processors 104 can include one or more different fields corresponding to a predefined translation.

Some translations can include predefined translations between differently formatted, organized, arranged, or other data fields. The data fields can be data fields of a data structure such as a relational database, or derived from computer-readable instructions (e.g., a constant, configuration setting, or relationship therebetween included in program code). Either of the data structure or instructions may be or a constituent to an issuer entity. The translation can concatenate, truncate, omit, or otherwise translate one or more data fields between interfaces. For example, an issuing processor connection 113 or uniform interface 101 can store a phone number according to a country code, or according to a phone type (e.g., cellular phone or home phone). Another interface can include flag bits for whether a phone can accept text messages, or whether a mobile wallet instance is hosted by the phone. The entity translator 310 can translate between the fields, which can include accessing further data sources (e.g., an indication of whether a particular phone hosts a mobile wallet can be stored at another location in a relational database, in another data structure, etc.).

The entity translator 310 can store one or more of the data fields according to a local data structure (e.g., a local cache), or convey any information between any connected interface. The entity translator 310 can further include or store outputs or inputs of the various translation operations. For example, one translation can include casting a string data type to an integer data type. Another translation can include comparing a first data field to a predefined value, and defining a second data field based on the value (e.g., the telephone number stored in a data field based on a bit flag value).

In some instances, translations may be dynamic, such as translations based on time of day, geographic location, or so forth. For example, a data field can correspond to a location of a user, a distance to a merchant, a geographic location or municipality such as a city, state, or country. A translation can depend upon available data and vary over time. For example, a card present bit can be determined according to swipe data 324 (e.g., a physical presence of a card), a coextensive location of a mobile device associated with a mobile wallet, and a merchant location associated with a transaction, or other data. A card present indication at one interface can include a bit flag indication, wherein a card present bit at another interface can include an indication of a source of the card present bit (e.g., may distinguish between a physical card presence such as an contactless “tap” card swipe, an insertion of a chip, a presence of a mobile wallet at a location associated with a transaction, or another verification method, such as a secondary online verification to establish a card present classification). The entity translator 310 can translate the card present indication according to a current or historical location of a user. For example, wherein a mobile device includes location data, or a cardholder provides swipe data 324 at a further merchant prior or subsequent to a transaction of interest, the entity translator 310 can determine a presence of a cardholder at the transaction of interest according to such location data (e.g., a card used at a merchant fifty miles from another transaction within five minutes, or from a mobile device of the user may not be indicative of a presence of the cardholder or card associated with the transaction of interest).

The entity translator 310 can interface with any number of data enrichment sources 260 to correct, modify, generate, or enhance data. A data enrichment source 260 can maintain merchant, cardholder, or other information. For example, the data enrichment source 260 can include a street address corresponding to a vendor location, or a vendor name (e.g., a vendor identifier of 987654-WMT S SLC UT 12345, can correspond to “Walmart store #12345, 123 Main Street, Salt Lake City Utah, 84415-1234). The entity translator 310 can identify information which does not correspond to a connected device or system (e.g., to one or more predefined formats for the uniform interface 101 or one or more of the issuing processor connections 113). For example, the entity translator 310 can determine a deviation between a data field and a data field associated with the uniform interface 101 or the connections 113. In response to the deviation, the entity translator 310 can provide the one or more data fields, information parsed therefrom, or another indication of data enrichment information (e.g., some data enrichment sources 260 can be configured to receive a numeric identifier for a unique merchant, such as 987654, some data enrichment sources 260 can be configured to receive a partial address, such as WMT S SLC UT, in combination with geographic data associated therewith, etc.). The entity translator 310 can receive a response from the data enrichment source 260 and update a data field with the enriched data. For example, the enriched data can correspond to a nested data structure of the electronic ledger 114 of the proprietary system.

The entity translator 310 can translate issuer entities according to a supported function of one or more issuing processors 104. For example, one issuing processor 104 can include a 7 day hold and a 30 day hold for transaction funds, wherein another issuing processor 104 may include only the 30 day hold. The entity translator 310 can issue a 30 day hold with the other issuing processor, and release the hold after 7 days to effect a 7 day hold. The entity translator 310 can provide, to the uniform interface 101, a same field associated with the explicit 7 day hold, or the 30 day hold which will be released after 7 days have elapsed. In another example, one issuing processor 104 can support incremental authorizations and another may not. The entity translator 310 can effect an incremental authorization by placing a hold, and thereafter releasing the hold and approving a separate transaction. For example, such information may be stored according to a nested data structure of the electronic ledger 114 of the proprietary system 110, such that the proprietary system 110 may interfere with the various issuing processors 104, as intermediated by the issuing processor aggregator 102, without generating separate fields for the various issuing processors 104.

Any of the translations of the entity translator 310 can be configured to translate between any of the issuing processor connections 113 and the uniform interface 101. Thus, the issuing processor aggregator 102 can present a single interface to any device connected thereto, along with the uniform interface 101 of the proprietary system 110. For example, any data enrichment sources 260 or other connections to the issuing processor aggregator 102 can be provided regardless of a selected or active IPIF 112, such that enrichment data may be available to more than one of the selected IPIF 112. For example, upon a change of a selection of an issuing processor 104, the connections to a data enrichment source 260 can be maintained, wherein any information can be translated, by the entity translator 310. The change of selection of the issuing processor 104 can be on a transaction basis, such as in response to receiving a card network 108 that is not supported by an issuing processor 104, or based on a replacement of one issuing processor 104 with another.

FIG. 4 is a flowchart of a method 400 to manage transactions, according to some implementations. The method 400 can be performed by one or more processing circuits of one or more devices of FIG. 1. For example, the processing circuits can be or include processing circuits of the issuing processor aggregator 102. In broad overview of the method 400, at block 410, the one or more processing circuits can receive transaction data. At block 420, the one or more processing circuits can parse the transaction data. At block 430, the one or more processing circuits can create a transaction record. At block 440, the one or more processing circuits can determine a transaction authorization. At block 442, the one or more processing circuits can determine an expiration of an authorization. At block 444, the one or more processing circuits can transmit to the ledger the transaction data, the transaction authorization. At block 450, the one or more processing circuits can clear a transaction, based on the determination of the authorization. At block 455, the one or more processing circuits can effect expiration of an authorization that has not been cleared. At block 460, the one or more processing circuits can transmit the transaction record for ledger recordation. Additional, fewer or different operations may be performed depending on the particular arrangement. In some embodiments, some, or all operations of the method 400 may be performed by one or more processors executing on one or more computing devices, systems or servers. In various embodiments, each operation may be re-ordered, added, removed or repeated.

Referring again to block 410, the one or more processing circuits can receive transaction data. The transaction data can include transaction data corresponding to an initial swipe action, or modifications, appendages, or other additions thereto. For example, the swipe data 324 can be provided by a physical or virtual card at a point of sale. The point of sale can include a POS terminal physically located at a merchant (e.g., as in the case of a tap to pay, physical swipe, chip insertion). The point of sale can include a virtual POS device (sometimes referred to as an eCommerce POS or Online POS). The swipe data can include an account number or other identifier (or portion thereof). For example, the swipe data can include a BIN which may be indicative of an issuing processor 104, a card program, or other aspects of card data 326.

The one or more processing circuits can receive transaction data for any number of transactions. One or more received messages can correspond to each transaction, such as an initial swipe and any number of subsequent messages associated with the swipe (e.g., cancelations, adjustments, or the like). Each transaction can relate to a separate transaction associated with one or more merchants. The transaction data can include information from the merchant POS or from any other device in network communication therewith (e.g., operations 211, 212, 213, 214, or 215 of FIG. 2).

Referring again to block 420, the one or more processing circuits can parse, from the transaction data, a set of transaction data for each transaction. For example, the transaction data can include an amount of a transaction (e.g., a transaction amount, approval amount, hold amount, or other amount), a transaction time, a category code (e.g., MCC), or any other information associated with a transaction (e.g., a card present indicator, a transaction type, a geographic location, or so forth). The parsing can be according to a predefined format or data location in an issuer entity (e.g., of a comma separated list, a relational database, or another data structure). The parsing can be according to a content of the data. For example, the entity translator 310 can determine a predetermined data item corresponding to a data type (e.g., of a phone number account number, name, or so forth). Indeed, the entity translator 310 can parse any portion of the transaction data to translate information disposed therein according to the various translation operations as described with regard to, for example, FIG. 3. For example, the entity translator 310 can generate transaction data configured for interoperation with the uniform interface 101 or various further interfaces, such as any of the issuing processor connections 113.

Referring again to block 430, the one or more processing circuits can create a transaction record according to the transaction data. The transaction record can include the parsed information, along with any number of translations thereof. The transaction record can include one or more instances of the data record items. The instances can be configured to interface with one or more interfacing components, such as the proprietary system 110 (e.g., an electronic ledger 114 thereof) via the uniform interface 101 or any of the issuing processors 104 via a connection 113 thereto.

Referring again to block 440, the one or more processing circuits can determine authorization of the transaction. For example, the determination of the authorization can include determining the authorization according to at least an available balance of an account maintained in an electronic ledger 114. The authorization can be determined, by the transaction authorizer 308, for example, such as according to locally cached or stored instance of authorization data, or via messages conveyed, across the uniform interface 101, to the proprietary system (e.g., an available balance of an account maintained in the electronic ledger 114).

Referring again to block 442, the one or more processing circuits can determine an expiration of an authorization. The transaction data and/or the transaction record can be compared to rule data. The transaction data is compared to the rule data to determine whether a match occurs for the transaction data and the rule data. For example, the comparing can include comparing each value of the set of one or more values of the one or more attribute fields to corresponding attribute data of the transaction data to determine whether a match occurs. If a match occurs, a transaction expiration is set to the expiration value. For example, an authorization expiration field of a transaction record may be populated with the expiration value.

Referring again to block 444, the one or more processing circuits can transmit to the ledger the transaction data and the transaction authorization. Optionally, the expiration value of the transaction can be transmitted to the ledger. The ledger can adjust the available balance according to the transaction authorization to that the authorized funds are in effect “held” until the transaction clears.

Referring again to block 450, the one or more processing circuits can clear a transaction record. The transaction record can be cleared responsive to an authorization output, such as an authorization approval or a message with another authorization response (e.g., for an incremental approval). The transaction record can be batched with zero or more additional transaction records to form a transaction record batch (e.g., zero or more approved transactions). The issuing processor aggregator 102 can provide the batched transaction records according to a predefined time (e.g., hourly, daily, or so forth). The issuing processor aggregator 102 can pass the batched transaction records via an issuing processor connection 113 to an issuing processor 104 (including any adjustments between batches of the various interfaces, such as by generating null messages or casting periodic messages as notifications). The issuing processor 104 may, in turn, provide the batched transaction records to an issuing provider, card network 108, acquiring provider, or merchant.

Referring again to block 455, the one or more processing circuits can effect expiration of an authorization that has not been cleared, according to an expiration value of a transaction record. In some instances, and authorized transaction is not carried out and/or never clears. An authorization for a transaction at a gas station may not clear if the gas is never pumped. An authorization for a transaction at a hotel at some future time may not complete or otherwise clear if the prospective guest cancels the reservation. Effecting the expiration of the authorization, according to the expiration value, can enable updating the available balance according to the expired transaction, thereby freeing up funds.

Referring again to block 460, the one or more processing circuits can transmit the transaction record for ledger recordation. For example, the transaction records may be provided as uniform to the plurality of issuing processor integration interfaces. For example, the transaction record (or a batch thereof), can be configured for provision to any of the IPIF 112, or the uniform interface 101 for ledger recordation. The ledger can include an electronic ledger 114 of the proprietary system 110 or various further ledgers which may be maintained, provided, or interfaced with the various further system architecture 200 components depicted in FIG. 2 (e.g., a merchant, acquiring provider, card network 108, or issuing provider, or issuing processor ledger).

The transmitted transaction record can communicate the actual amount of the transaction (as compared to the authorized amount) for updating an available funds balance. The transmitted transaction record can also communicate an expiration of the transaction—i.e., that the authorization expiration-such that an update to the available funds balance can be reversed for the expired transaction that was never carried out.

FIG. 5 is a flowchart of a method 500 to configure authorization expiration, according to some implementations. At block 510, rule data is received (e.g., user input) that can include one or more rules defining an expiration value, attribute field-value pairs, and any combining logic. At block 512, a transaction authorization request is received. The transaction authorization request includes transaction data for a transaction to be authorized. The transaction data can include attributes of the transaction, which can include, but are not limited to merchant category code, merchant name, merchant descriptor, merchant currency, merchant address, merchant city, merchant state, merchant postal code, and merchant country. The attributes of the transaction can correspond to attribute field-value pairs of the rule data. At block 514, a transaction record (e.g., transaction data set, transaction data structure) may be created for the transaction corresponding to the transaction authorization request. The transaction record can include the transaction data. The transaction record can include an authorization expiration field for indicating when authorization for the transaction expires. The transaction record can include one or more status indicators to indicate one or more of “authorized” (or approved), “pending,” “cleared,” “voided,” “expired,” and or any other status or state that a transaction may be in during processing. At block 516, the transaction data may be compared to an available balance to determine approval of the authorization request. If, for example, the available balance is sufficient for a transaction amount of the transaction for which authorization is being requested, the authorization request may be approved, and the transaction may be authorized. If the available balance is insufficient for the transaction amount, the authorization request may be denied and the authorization may be unapproved or unauthorized. The determined approval can be recorded in the transaction record.

At block 518, the transaction data can also be compared to rule data to determine a match. The comparison may occur before, after, or in conjunction with approval of the authorization request. The transaction data includes transaction attributes that can correspond to attribute field-value pairs of rules of the rule data. The transaction attributes can be compared to the value(s) of corresponding attribute field-value pairs of the rule(s) to determine if there is a match. At block 520, if there is a match (e.g., a matching transaction attribute and matching rule attribute field value), a transaction authorization expiration can be set according to the rule. For example, a transaction authorization expiration field of the transaction record can be set according to the expiration value of the matching rule. If the transaction does not match any rule, the expiration may be set according to a default expiration value.

At block 522, the transaction record (or transaction data) is transmitted to the ledger system for accounting for the transaction. The ledger system may be configured to adjust or update an available balance based on the transaction data. If $200 is authorized, that amount would be counted against the available balance. Stated otherwise, the transaction is considered, by the ledger, as withdrawn from the account, such that the available balance for future authorization requests will reflect all authorized (and thus all potential) transactions.

At block 524, there is monitoring of the transaction record (and any other pending or otherwise outstanding or uncleared transaction records). There may be monitoring for clearing of the transaction associated with the transaction record. There is monitoring for expiration if the transaction is not cleared. The expiration field of the transaction record may be compared or otherwise considered relative to a current time (and/or potentially a transaction time or start time) to determine if the expiration value is met or satisfied. As described, the expiration value can comprise one or more of a point in time, a date, a duration, a period, or any other suitable value for indicating a point at which expiration for authorization of the transaction is to occur. With some appropriate regularity, the transaction record is examined or otherwise monitored to determine if it remains uncleared (e.g., pending, outstanding) and if the expiration value is met or past. At block 526, if the transaction remains pending or otherwise uncleared at a current time corresponding to the transaction authorization expiration, then the transaction record is updated to reflect expiration, or some other action can effectuate expiration of the transaction authorization. For example, a status of the transaction record may be updated to reflect “voided” or “expired.” At block 528, an indication of expiration of the transaction authorization is transmitted to the ledger system. For example, the updated transaction record (with a status set to “voided” or “expired”) may be transmitted to the ledger system. The ledger system is configured to reverse the update to the available balance, according to the transaction authorization expiration. The available balance is adjusted by the ledger system to no longer account for the authorized funds of the expired transaction, because those funds are no longer authorized.

A creditor (lender) may wish to ensure a line of credit is not overdrawn. A deposit bank may desire to ensure a deposit account is not overdrawn. A prepaid card issuer may have a strong interest that prepaid funds are not disbursed twice. Counting authorized funds against an available balance is a key to ensuring funds are not overspent (or double-spent). However, when authorized transactions are not completed (or otherwise remain uncleared) an authorized amount recorded on a ledger is in essence held and cannot be used until the authorization is expired. As can be appreciated, unnecessary holding of funds results in other challenges, including missed opportunities for future transactions, potentially disgruntled customers, and/or loss thereof. If the expiration period is too long, then future authorization requests may be denied (e.g., for insufficient available balance), leading to loss of fees for such transactions and deposit holders. In contrast, if the expiration period is too short, then merchants and/or customers may be unduly inconvenienced by, for example a later denial of a transaction for lack of an affirmative or pending authorization, which case other payment vehicles or modes may be frustratingly selected. The method 500 can enable users to configure expiration values that are appropriate—to effectively protect against overspending or double spending and to also not hold funds for unnecessarily excess time.

FIG. 6 is a block diagram illustrating example details of the available credit service 132, according to some implementations. The example details are provided for illustration purposes and are not limiting. The available credit service 132 may include some of the example details shown, all of the example details shown, none of the example details shown, and/or different details.

The available credit service 132 may include a first loan 610, a second loan 620, a debit account 630, and a prepaid account 640. For ease of communication, the available credit service 132 is referred to as including the first loan 610, the second loan 620, the debit account 630, and the prepaid account 640, and the available credit service 132 may include data entries corresponding to each, a single data structure including data entries for each, separate data structures including data entries for each, and/or a database including data entries for each of the first loan 610, the second loan 620, the debit account 630, the prepaid account 640, the available credit service 132, and corresponding data. Similar language is used for ease of communication when discussing other concepts, data, or digital information.

The available credit service 132 may include a first available credit 612, a second available credit 622, an available funds 632, and an available balance 642. The first available credit 612 may correspond to the first loan 610, representing an available credit of the first loan 610. The first available credit 612 may be a real-time available balance or real-time available credit, as discussed in FIG. 2. The second available credit 622 may correspond to the second loan 620, representing an available credit of the second loan 620. The second available credit 622 may be a real-time available balance or real-time available credit, as discussed in FIG. 2. The available funds 632 may correspond to the debit account 630, representing available funds of the debit account 630. The available funds 632 may be a real-time available balance or real-time available funds, as discussed in FIG. 2. The available balance 642 may correspond to the prepaid account 640, representing an available balance of the prepaid account 640. The available balance 642 may be a real-time available balance as discussed in FIG. 2. Used generally herein, the term “real-time available balance” refers to any type of real-time amount of available funds or credit associated with an account.

The available credit service 132 may include accounts and corresponding balances, funds, or credits, allowing for flexibility of accounts which may be provided to the issuing processor aggregator 134 for comparison with transaction data. The available credit service 132 may include real-time available balances, as discussed in FIG. 2, for each of the accounts included in the available credit service 132. In an example, the first loan 610 is a credit card account and the first available credit 612 is a real-time available credit of the credit card account with all fees, interest, payments, and pending transactions applied. In an example, the second loan 620 is a revolving line of credit and the second available credit 622 is a real-time available credit of the revolving line of credit with all fees, interest, payments, and pending transactions applied. In an example, the debit account 630 is a debit card account and the available funds 632 is a real-time available funds of the debit card account with all fees, payments, and pending transactions applied. In an example, the prepaid account 640 is a gift card account and the available balance 642 is a real-time available balance of the gift card account with all fees, deposits, and pending transactions applied. By receiving real-time available balances, available credits, and available funds, the available credit service 132 is able to store real-time values for loans, credit cards, debit cards, gift cards, and other accounts for comparison against transaction data. In this way, the available credit service 132 is able to flexibly provide data for comparison against transaction data for a variety of different account types. This represents a technical improvement over conventional systems, which are generally limited to applying transaction data to estimated balances for a single type of account. By consolidating the balance information for multiple types of accounts in the available credit service 132, the system conserves network connections and reduces latency. Furthermore, by sending real-time balances of the various account types to the available credit service 132 from the line of credit engine 110, the system reduces consumption of compute resources.

The available credit service 132 includes accounts associated with one or more users. In some implementations, the first available credit 612, the second available credit 622, the available funds 632, and the available balance 642 are accounts associated with a single user. In some implementations, the first available credit 612, the second available credit 622, the available funds 632, and the available balance 642 are accounts each associated with a different user. In some implementations, one or more of the first available credit 612, the second available credit 622, the available funds 632, and the available balance 642 are accounts associated with one or more users. In this way, the available credit service 132 is able to provide account information and corresponding real-time balances for accounts of various types and associated with various users.

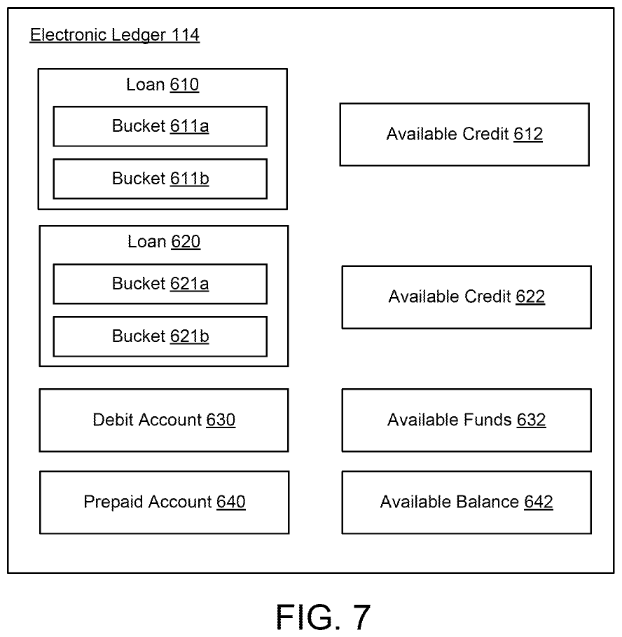

FIG. 7 is a block diagram illustrating example details of the electronic ledger 114, according to some implementations. The electronic ledger 114 may include the first loan, the second loan, the debit account 630, the prepaid account 640, the first available credit 612, the second available credit 622, the available funds 632, and the available balance 642 as included in the available credit service 132 in FIG. 6. The information in the electronic ledger 114 may correspond to the information in the available credit service 132, as the line of credit engine 110 transmits information including real-time available balance information to the authorization engine 130.

The electronic ledger 114 may include account information and balances for a variety of different account types. The electronic ledger 114 and/or the line of credit engine 110 may perform calculations for each account based on its account type and transactions associated with the account. In an example, the electronic ledger 114 may calculate interest, fees, and payments for a credit card account, a loan account, or a revolving line of credit account. In an example, the electronic ledger 114 may calculate deposits and withdrawals for a debit account. The electronic ledger 114 may calculate real-time available balances for each account based on its account type and transactions associated with the account. The line of credit engine 110 may send the real-time available balances to the available credit service 132. In this way, the available credit service 132 is able to provide real-time available balances to the issuing processor aggregator 134 for comparison to transaction data without performing any calculations. By concentrating the calculation of the real-time available balances at the line of credit engine 110, the available credit service 132 is able to provide balance information for a variety of account types and conserve computing resources.

The electronic ledger 114 may include a first bucket 611a and a second bucket 611b for the first loan 610. The first bucket 611a may represent a first category of transaction for the first loan 610 and the second bucket 611b may represent a second category of transaction for the first loan 610. The first bucket 611a and the second bucket 611b, referred to collectively as buckets 611, provide additional data to a user regarding transactions conducted using the first loan 610. A user may create the buckets 611 and assign amounts to the buckets to track and/or control spending. In an example, the first bucket 611a may be a fuel expenses bucket and the second bucket 611b may be an office supplies bucket. In this example, the transaction allocation engine 118 may assign transactions to the fuel expenses bucket, the office supplies bucket, or another bucket of the first loan 610 to allow the user to track and/or control spending across these categories.

The electronic ledger 114 may include a first bucket 621a and a second bucket 621b for the second loan 620. The first bucket 621a may represent a first category of transaction for the second loan 620 and the second bucket 621b may represent a second category of transaction for the second loan 620. The first bucket 621a and the second bucket 621b, referred to collectively as buckets 621, provide additional data to a user regarding transactions conducted using the second loan 620. A user may create the buckets 621 and assign amounts to the buckets to track and/or control spending. In an example, the first bucket 621a may be a reimbursement expenses bucket and the second bucket 621b may be a tax-deductible expenses bucket. In this example, the transaction allocation engine 118 may assign transactions to the reimbursement expenses bucket, the tax-deductible expenses bucket, or another bucket of the second loan 620 to allow the user to track and/or control spending across these categories.

In some implementations, the electronic ledger 114 includes buckets for the debit account 630 and/or the prepaid account 640.

FIG. 8 is a block diagram illustrating example details of a comparator 230, according to some implementations. The comparator 230 can be included in or utilized by an authorization engine, an issuing processor aggregator, and/or an available balance service. The comparator 230 can include or utilize a transaction authorizer 802 and an expiration monitor 804. The comparator 230 can include or otherwise access transaction records 810 and expiration rules 820.

The transaction authorizer 802 can determine an authorization for a transaction. For example, the transaction authorizer 802 can interface with an electronic ledger (e.g., to determine and/or access an available balance) and an issuing processor (e.g., to receive transaction data) to authorize and clear a transaction. The transaction authorizer may compare available balance data 822 and transaction data 824 to determine if an account (e.g., line of credit, deposit account, pre-paid account) has sufficient available balance for a transaction amount. The transaction authorizer may provide an indication of authorization (to the comparator, an authorization engine, an issuing processor, a ledger). The available balance 822 data may be received from an available balance service. The transaction data may be received from an issuing processor and/or from a transaction record 810.

The expiration monitor 804 can enable configuring of expiration of transactions and, based on an expiration value 842 of an expiration rule 820 and transaction data 844, determine if a transaction authorization is expired. The transaction data 844 is for a transaction that is authorized by the transaction authorizer 802 and may be the same, similar, or different data as the transaction data 824 considered by the transaction authorizer 802. The expiration monitor 804 includes an user interface 846 to receive input from a user (e.g., creditor (lender), deposit account bank, prepaid card issuer, etc.). The input may include rule data for defining one or more expiration rules 820. The rule data, and more specifically an expiration rule 820, can include an expiration value, attribute field-value pairs, and any logic for combining multiple attribute field-value pairs. A user can provide the rule input and the rule data is provided to the comparator 230, for example either to generate an expiration rule 820 or in the form of an expiration rule. The expiration monitor 804 can consider incoming transaction, or transaction data 844 for incoming transactions, and set an expiration of the authorization of a transaction according to the transaction rules 820. The expiration monitor 804 can then continually or regularly monitor uncleared transaction records for expiration.

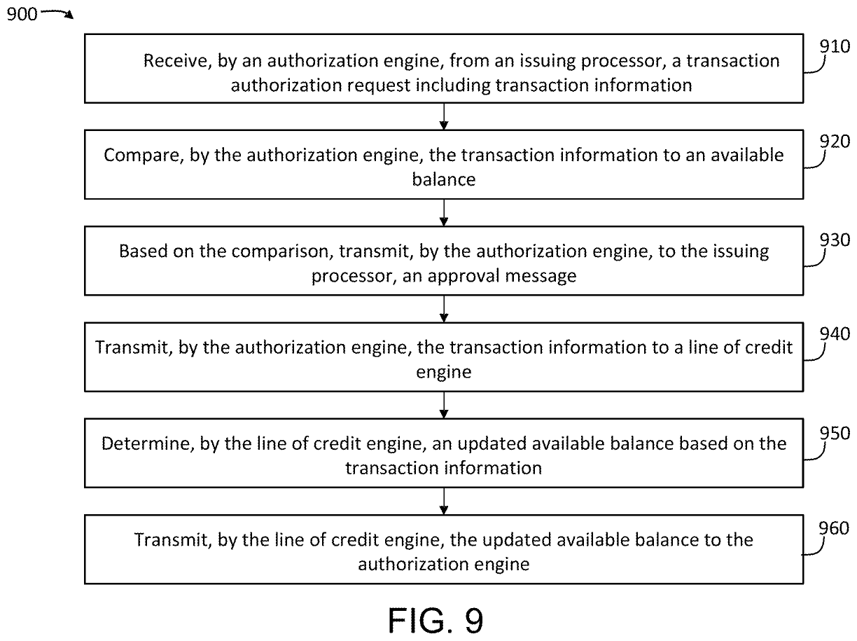

FIG. 9 is a flowchart illustrating example operations in a method 900 for approving or denying transactions. The method 900 may be performed by one or more components of the system architecture 200 of FIG. 2. The method 900 may be performed by the authorization engine 130 and/or the line of credit engine 110. The method 900 may include more, fewer, or different operations. The operations may be performed in the order shown, in a different order, or concurrently.

An authorization engine may receive 910, from an issuing processor, a transaction authorization request including transaction data. The transaction authorization request may be to approve or deny a transaction. The transaction may be initiated by a cardholder at a merchant, prompting a chain of messages between various computing devices and/or servers to authorize the transaction. The transaction data may include a transaction amount and an account identifier of an account associated with the cardholder. In some implementations, the transaction data may include a merchant identifier, one or more merchant category codes (MCCs), a transaction type (e.g., online, in-person, swipe, chip, tap, etc.), a transaction location, a transaction description, an identifier of goods or services, and/or other information regarding the transaction. The authorization request may include some or all of the transaction data. In some implementations, the authorization request includes only the information required by the authorization engine to authorize or deny the transaction. In an example, the authorization request may include a transaction amount so the authorization engine can determine whether the account associated with the cardholder has sufficient available funds or sufficient available credit for the transaction.

The authorization engine may compare 920 the transaction data to an available balance. Comparing the transaction data may include comparing a transaction amount of the transaction data to the available balance. The available balance may be received from a line of credit engine. The available balance may be a real-time available balance that accurately reflects the real-time available balance calculated at the line of credit engine. The line of credit engine may calculate the real-time available balance, applying all fees, interest, pending charges, payments, and other inputs that affect the available balance and transmit the real-time available balance to the authorization engine. The authorization engine may compare the transaction data to the real-time available balance to accurately determine whether the account has sufficient available funds and/or available credit to complete the transaction. In this way, the authorization engine can, without calculating the available balance, use the real-time available balance provided by the line of credit engine to determine whether to approve or deny the transaction. In some implementations, the line of credit engine may push the real-time available balance to the authorization engine. In an example, each time a calculation is applied to the real-time available balance, or each time the real-time available balance is updated, the line of credit engine pushes the real-time available balance, or updated real-time available balance to the authorization engine.

The authorization engine may transmit 930, based on the comparison, an approval message to the issuing processor. The authorization engine may transmit 930 the approval message to the issuing processor based on the available balance indicating that sufficient funds or credit are available to pay for the transaction. In an example, the authorization engine transmits the approval message based on the available balance being higher than the transaction amount. The authorization engine may transmit 930 the approval message based on the authorization engine determining to approve the transaction.

The authorization engine may, based on the comparison, deny the transaction. The authorization engine may deny the transaction based on the available balance indicating that the account has insufficient funds or credit available to pay for the transaction. The authorization engine may determine to deny the transaction. The authorization engine may transmit a denial message to the issuing processor to deny the transaction. In some implementations, the authorization engine may allow a response time to expire in order to deny the transaction. In some implementations, use of the real-time available balance by the authorization engine may cause a transaction to be approved or denied when conventional systems would not approve or deny the transaction. In an example, use of the real-time available balance by the authorization engine may cause the authorization engine to approve a transaction that would be denied by a conventional system based on the real-time available balance reflecting a payment or pending transaction on the account. In an example, use of the real-time available balance by the authorization engine may cause the authorization engine to deny a transaction that would be approved by a conventional system based on the real-time available balance reflecting a fee or pending transaction on the account. In an example, a conventional system may require synchronization between an issuer processor and a line of credit ledger, allowing a transaction to be incorrectly approved when fees and/or finance charges cause the available balance to be less than the transaction amount. In this example, the transaction may be approved due to the available balance seen by the issuer processor being stale and artificially high, as it does not include the fees and/or finance charges. In an example, a conventional system may require a line of credit ledger of a bank to approve transactions, where approved (but not yet cleared) transactions are not reflected in the line of credit ledger, causing transactions to be incorrectly approved based on the available balance in the line of credit ledger being stale and artificially high, as it does not reflect the approved but not cleared transactions. In this example, transactions may be incorrectly denied based on the available balance in the line of credit ledger being stale and artificially low, as it does not reflect transactions that were approved but which then expired without being cleared.

The authorization engine may transmit 940 the transaction data to the line of credit engine. The authorization engine may transmit 940 the transaction data to the line of credit engine in response to the authorization engine approving the transaction and/or receiving a notification that the transaction has been completed.

In some implementations, the method 900 includes transmitting, by the authorization engine, the transaction data to a data enrichment engine and receiving, by the authorization engine, from the data enrichment engine, enriched transaction data. The enriched transaction data may include additional information, such as MCC determinations, transaction categories, rewards program information, spending metrics, and other information. In some implementations, transmitting, by the authorization engine, the transaction data to the line of credit engine includes transmitting the enriched transaction data to the line of credit engine. The line of credit engine may use the enriched transaction data to determine one or more buckets or categories for the transaction.

The line of credit engine may determine 950 an updated available balance based on the transaction data. In some implementations, determining 950 the updated available balance includes updating a balance category or bucket of the available balance. Updating the balance category or bucket of the available balance may include determining, based on the transaction data, a transaction category corresponding to the balance category or bucket. In an example, the line of credit engine may determine that the transaction is at a merchant associated with fuel purchases with an MCC for fuel purchases and determine that the transaction belongs in a fuel purchases category or bucket of an account associated with the transaction. In this example, the transaction may be applied to the fuel purchases category or bucket and the available balance is updated based on an updated bucket total of the fuel purchases category or bucket. The updated available balance may be a real-time updated available balance with all real-time available information and/or calculations applied to the real-time available balance, including the approved transaction.

The line of credit engine may transmit 960 the updated available balance to the authorization engine. The authorization engine may receive the updated available balance from the line of credit engine. Transmitting the updated available balance to the authorization engine may include transmitting the real-time updated available balance to the authorization engine. In some implementations, the line of credit engine may transmit the updated available balance to the authorization engine in response to calculating the updated available balance. In some implementations, the line of credit engine may transmit the updated available balance to the authorization engine at regular intervals.

In some implementations, the available balance, the updated available balance, the real-time available balance, and/or the real-time updated available balance are each a single number. In this way, the authorization engine does not have to perform any calculations to obtain the available balance, the updated available balance, the real-time available balance, and/or the real-time updated available balance. In addition, sending the updated available balance, the real-time available balance, and/or the real-time updated available balance each as single numbers conserves network bandwidth and other network resources. Moreover, sending the updated available balance, the real-time available balance, and/or the real-time updated available balance each as single numbers allows for flexibility in receiving available balances from a variety of different line of credit engines, for a variety of different accounts, and for a variety of different account types. In some implementations, a common format is used for receiving the available balances. In an example, a JSON format is used for receiving the updated available balance, the real-time available balance, and/or the real-time updated available balance.

In some implementations, the authorization engine includes a first available balance associated with a first user and a second available balance associated with a second user. The authorization engine may include multiple available balances associated with multiple different users. The first available balance may be a different type of available balance than the second available balance. In an example, the first available balance is an available credit amount for a credit card and the second available balance is an available funds amount for a debit card or gift card. In this way, the authorization engine can aggregate authorizations for multiple different users.

In some implementations, the authorization engine includes a first available balance associated with an available credit amount and a second available balance associated with an available funds amount. In an example, the first available balance is an available credit amount for a credit card and the second available balance is an available funds amount for a debit card or gift card. The first available balance and the second available balance may be associated with accounts belonging to different users. In this way, the authorization engine aggregates transaction authorizations across multiple different users and account types.

In some implementations, the authorization engine receives available balances and/or updated available balances from a plurality of line of credit engines. The authorization engine may receive the available balances from the plurality of line of credit engines without having to calculate the available balances. By performing the calculations necessary to calculate the available balances at the plurality of line of credit engines, the authorization engine is able to aggregate available balances from the plurality of line of credit engines at scale. In this way, the authorization engine can include available balances from many more line of credit engines while conserving compute resources used by the authorization engine. As discussed herein, the available balances may be transmitted to the authorization engine each as single numbers, conserving network resources and also conserving compute resources at the authorization engine.

In some implementations, the authorization engine receives a plurality of transaction authorization requests from a plurality of issuing processors. The authorization engine may thus aggregate the plurality of authorization requests from the plurality of issuing processors at a single authorization engine. The authorization engine, in comparing transaction data against available balances, may simplify the authorization process compared to conventional systems, leading to lower latency, reduced usage of compute resources, and reduced usage of network resources.

In some implementations, the line of credit engine transmits and receives information from the authorization engine using a single communication channel. This may result in a more secure authorization pathway and reduced use of compute and network resources compared to conventional systems. Aggregating authorization requests from a plurality of issuing processors at the authorization engine allows for the available balance calculated at the line of credit engine to be compared to transaction data from the plurality of issuing processors without the line of credit having to establish a connection with each issuing processor. Instead, the line of credit engine can establish a single connection with the authorization engine and the authorization engine can authorize or deny authorization requests from the plurality of issuing processors. In this way, the available balance may be calculated only once at the line of credit engine, conserving compute resources, and the line of credit engine only needs a single communication channel with the authorization engine, conserving network resources.

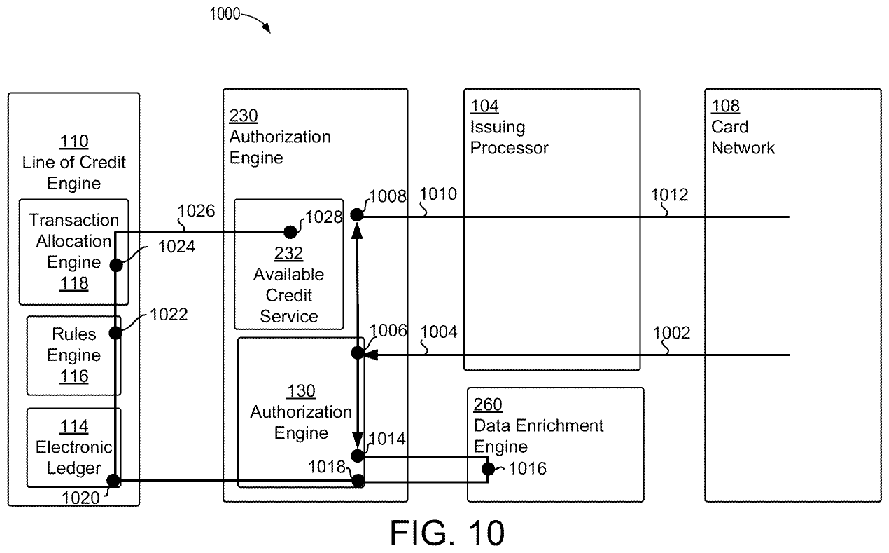

FIG. 10 is a flow diagram 1000 depicting transaction management, according to some implementations. The flow diagram 1000 can correspond to a flow of the method 900 of FIG. 9. The operations and messages described herein may be re-ordered, modified, adjusted, omitted, or further operations or messages may be included. Moreover, some messages or operations described herein in the singular can refer to multiple messages or operations, such as iterative or sequential operations or messages.

The card network 108 may provide an authorization request message 1002 to the issuing processor 104 responsive to an attempted transaction. For example, the card network 108 can receive swipe data corresponding to the swipe action from a merchant, via one or more intermediaries, such as an acquiring provider.

Responsive to the receipt of the message 1002 from the card network 108, the issuing processor 104 can provide a message 1004 to the authorization engine 130. At operation 1006, the authorization engine 130 can approve or deny the transaction based on one or more transaction rules (e.g., a comparison of a transaction amount to a stored value or an available credit associated with a card). The authorization may not be an only or final approval. For example, the issuing processor 104 can generate a first determination of authorization (e.g., an authorization, non-authorization, pre-authorization, or other operation). Further, the issuing processor aggregator 134 can approve or deny the transaction based on one or more messages (not depicted) within the authorization engine 130. For example, the issuing processor aggregator 134 may compare an available balance received from the available credit service 132 to the transaction data. At operation 1006, the authorization engine may determine an authorization expiration for the transaction.

At operation 1008, the authorization engine 130 may transmit an authorization message 1010 to the issuing processor 104. At operation 1012, the issuing processor may transmit an authorization message 1012 to the card network 108. In some implementations, the authorization message 1010 and the authorization message 1012 are the same.

At operation 1014, the issuing processor aggregator 134 may, responsive to authorizing the transaction, transmit the transaction data to a data enrichment engine 260. The data enrichment engine may use the transaction data to generate enriched transaction record data (e.g., based on a predetermined lookup function or another determination of a deviation between a data field of the transaction record and a uniform field corresponding thereto). At operation 1016, the data enrichment source 260 can provide the enriched transaction data based on the receipt of the transaction data from the issuing processor aggregator 134. The enrichment data source 260 can provide the enriched data to the authorization engine 130.

At operation 1018, the issuing processor aggregator may transmit the enriched transaction data to the line of credit engine 110. At operation 1020, the line of credit engine 110 receives the enriched transaction data. The line of credit engine 110 may update the electronic ledger using the enriched transaction data. At operation 1022, the rules engine 116 applies one or more rules to the enriched transaction data to determine one or more categories or buckets for the transaction. At operation 1024, the transaction allocation engine 118 allocates the transaction to the one or more categories or buckets and updates the available balance. The allocation engine 118 may update electronic ledger. At operation 1024, the transaction allocation engine 118 may transmit the updated available balance 1026 to the available credit service 132. At operation 1028, the available credit service may store the updated available balance for comparison with transaction data of future transactions. The updated available balance 1026 may be a real-time updated available balance, as discussed herein.

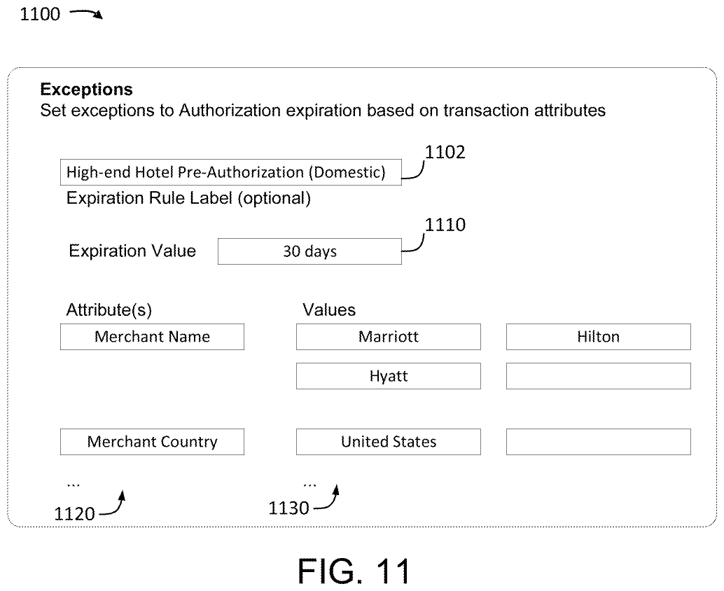

FIG. 11 is a user interface 1100 for configuring transaction authorization expiration, according to some implementations. The user interface 1100 includes an expiration value field 1110, attribute type input fields 1120, and value input fields 1130. A label field 1102 may be provided for naming the rule. A user can provide input to create rule data, or rules that specify the attributes of transactions and when such matching transactions should expire. The expiration value can be any suitable value for designating when authorization of a transaction should expire, including but not limited to: a number of seconds, minutes, hours, days, weeks, months, years, etc., a duration, a period, a point in time (e.g., 5:00 pm Eastern), a date (December 31). In the example of FIG. 11, the expiration value is “30 days.”

As depicted, a rule may be defined with one or more transaction attribute types or fields and a corresponding set of one or more values. In FIG. 11, an attribute type “Merchant Name” is provide and a corresponding set of values includes “Marriott,” “Hilton,” “Hyatt.” Additional values could be provided. This attribute type and corresponding set of values creates an attribute field-value pair. Logic operators (e.g., set logic, Boolean logic) or other operators can be used to indicate a desired combination of the set of values. For example, the rule may be satisfied if the “Merchant Name” of a transaction is equal to “Marriott” OR “Hilton” OR “Hyatt.”

In the example of FIG. 11, the rule being defined includes a second attribute type “Merchant Country.” The corresponding set of values includes a single value, “United States.” Logic operators or other operators can indicate a desired combination of attribute types. For example, a transaction may satisfy or otherwise meet the rule if the “Merchant Name” of the transaction matches AND the “Merchant Country” of the transaction matches. As another example, a transaction may satisfy or otherwise meet the rule if the “Merchant Name” of the transaction matches OR the “Merchant Country” of the transaction matches.

FIG. 12 illustrates an example computer system 1200. The computer system 1200 may be used, for example, to implement a issuing processor aggregator 134, line of credit engine 110, issuing processors 104, card networks 107, and/or various other example systems described in the present disclosure. The computing system 1200 includes a bus 1205 or other communication component for communicating information and a processor 1210 coupled to the bus 1205 for processing information. The computing system 1200 also includes main memory 1215, such as a random-access memory (RAM) or other dynamic storage device, coupled to the bus 1205 for storing information, and instructions to be executed by the processor 1210. Main memory 1215 can also be used for storing position information, temporary variables, or other intermediate information during execution of instructions by the processor 1210. The computing system 1200 may further include a read only memory (ROM) 1220 or other static storage device coupled to the bus 1205 for storing static information and instructions for the processor 1210. A storage device 1225, such as a solid-state device, magnetic disk, or optical disk, is coupled to the bus 1205 for persistently storing information and instructions.

The computing system 1200 may be coupled via the bus 1205 to a display 1235, such as a liquid crystal display, or active matrix display, for displaying information to a user. An input device 1230, such as a keyboard including alphanumeric and other keys, may be coupled to the bus 1205 for communicating information, and command selections to the processor 1210. In another implementation, the input device 1230 has a touch screen display 1235. The input device 1230 can include any type of biometric sensor, a cursor control, such as a mouse, a trackball, or cursor direction keys, for communicating direction information and command selections to the processor 1210 and for controlling cursor movement on the display 1235.

In some implementations, the computing system 1200 may include a communications adapter 1240, such as a networking adapter. In various illustrative implementations, any type of networking configuration may be achieved using communications adapter 1240, such as wired (e.g., via Ethernet), wireless (e.g., via Wi-Fi, Bluetooth), satellite (e.g., via GPS) pre-configured, ad-hoc, LAN, WAN.

According to various implementations, the processes that effectuate illustrative implementations that are described herein may be achieved by the computing system 1200 in response to the processor 1210 executing an implementation of instructions contained in main memory 1215. Such instructions may be read into main memory 1215 from another computer-readable medium, such as the storage device 1225. Execution of the implementation of instructions contained in main memory 1215 causes the computing system 1200 to perform the illustrative processes described herein. One or more processors in a multi-processing implementation may also be operated to execute the instructions contained in main memory 1215. In alternative implementations, hard-wired circuitry may be used in place of or in combination with software instructions to implement illustrative implementations. Thus, implementations are not limited to any specific combination of hardware circuitry and software.

That is, although an example processing system has been described in FIG. 12, implementations of the subject matter and the functional operations described in this specification may be carried out using other types of digital electronic circuitry, or in computer software embodied on a tangible medium, firmware, or hardware, including the structures disclosed in this specification and their structural equivalents, or in combinations of one or more of them. Implementations of the subject matter described in this specification may be implemented as one or more computer programs, e.g., one or more subsystems of computer program instructions, encoded on one or more computer storage medium for execution by, or to control the operation of, data processing apparatus. Alternatively, or in addition, the program instructions may be encoded on an artificially generated propagated signal, e.g., a machine generated electrical, optical, or electromagnetic signal, that is generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the implementations of FIG. 12 as singular, stand-alone devices, one of ordinary skill in the art will appreciate that, in some implementations, the computing system 1200 may include virtualized systems and/or system resources. For example, in some implementations, the computing system 1200 may be a virtual switch, virtual router, virtual host, or virtual server. In various implementations, computing system 1200 may share physical storage, hardware, and other resources with other virtual machines. In some implementations, virtual resources of the network may include cloud computing resources such that a virtual resource may rely on distributed processing across more than one physical processor, distributed memory, etc.

Some example implementations, according to the present disclosure, are now described.

An example system may include one or more processors and one or more non-transitory, computer-readable mediums including instructions which, when executed by the one or more processors, cause the system to: receive, at an authorization engine, rule data for defining an expiration for transaction authorizations, the rule data including an expiration value and one or more attribute field-value pairs; receive, at the authorization engine, from an issuing processor, over a communication network, a transaction authorization request for a transaction, the transaction authorization request including transaction data. If the transaction authorization request is approved, the instructions which, when executed by the one or more processors, cause the system to: compare, by the authorization engine, the transaction data to the rule data to determine whether a match occurs for the transaction data and the rule data; if the match occurs, set the transaction authorization to expire according to the expiration value; transmit, by the authorization engine, the transaction data to a ledger system, wherein the ledger system is configured to update an available balance based on the transaction data; monitor for expiration of the transaction authorization according to the transaction expiration; and transmit, by the authorization engine, an indication of expiration of the transaction authorization to the ledger system, wherein, the ledger system is configured to reverse the update to available balance, according to the transaction expiration.

In the example system, further instructions, when executed by the one or more processors, cause the system to: receive, from the ledger system, the updated available balance; and receive, from the ledger system, the available balance with the update reversed. In the example system, further instructions, when executed by the one or more processors, cause the system to: receive at the authorization engine, over a communication network, a default expiration value; and if the match fails to occur, set a transaction authorization expiration to the default expiration value. In the example system, the rule data further includes one or more of set logic and Boolean logic for combining attribute field-value pairs, wherein the comparing the transaction data to the rule data to determine whether a match occurs is according to the one or more of the set logic and Boolean logic. In the example system, further instructions, when executed by the one or more processors, cause the system to: compare, by the authorization engine, the transaction data to an available balance to determine an authorization status; and transmit, by the authorization engine, to the issuing processor, the authorization status. In the example system, the comparing, by the authorization engine, the transaction data to the rule data comprises comparing each value of the set of one or more values of the one or more attribute fields to corresponding attribute data of the transaction data to determine whether a match occurs. In the example system, the expiration value is one of: a point in time, a time period, or a duration. In the example system, further instructions which, when executed by the one or more processors, cause the system to provide a user interface to a client computing device, for presenting to a user, the user interface to receive and transmit to the authorization engine the rule data. In the example system, the attribute field-value pairs each comprise an attribute field and a set of one or more values that correspond to the attribute field. In the example system, the attribute field is one of a merchant category code, merchant name, merchant descriptor, merchant currency, merchant address, merchant city, merchant state, merchant postal code, and merchant country. In the example system, monitoring for expiration of the transaction comprises considering the transaction expiration relative to a current time and considering a status of the transaction. In the example system, further instructions which, when executed by the one or more processors, cause the system to: create a transaction record according to the transaction data, wherein setting the transaction authorization to expire comprises setting a field of the transaction record according to the expiration value.

An example method for configuring transaction authorization expiration may include: receiving, at an authorization engine, rule data for defining an expiration for transaction authorizations, the rule data including one or more attribute fields, a set of one or more values for (e.g., corresponding to) each of the one or more attribute fields, and an expiration value; receiving, at the authorization engine, from an issuing processor, over a communication network, a transaction authorization request for a transaction, the transaction authorization request including transaction data; if the transaction authorization request is approved: comparing, by the authorization engine, the transaction data to the rule data to determine whether a match occurs for the transaction data and the rule data; if there is a match, setting a transaction authorization expiration to the expiration value; transmitting, by the authorization engine, the transaction data to a ledger system, wherein the ledger system is configured to update an available balance based on the transaction data; if the transaction remains pending at a current time corresponding to the transaction authorization expiration, effecting (e.g. effectuating), by the authorization engine, expiration of the transaction authorization; transmitting, by the authorization engine, in indication of expiration of the transaction authorization to the ledger system, wherein the ledger system is configured to reverse the update to the available balance, according to the transaction authorization expiration.

In the example method, further comprising: receiving, at the authorization engine, the updated available balance; and receiving, at the authorization engine, the available balance with the update reversed. In the example method, further comprising: receiving, at the authorization engine, a default expiration value; and if the match does not occur, setting, by the authorization engine, a transaction expiration to the default expiration value. In the example method, the rule data further includes one or more of set logic and Boolean logic for combining two or more of the attribute fields of the one or more attribute fields, wherein the comparing the transaction data to the rule data to determine whether a match occurs is according to the one or more of the set logic and Boolean logic. In the example method, the rule data further includes one or more of set logic and Boolean logic for combining one or more of the values of a given set of values of a given attribute field, wherein the comparing the transaction data to the rule data to determine whether a match occurs is according to the one or more of the set logic and Boolean logic. In the example method, further comprising: comparing, by the authorization engine, the transaction data to an available balance to determine an authorization status; and transmit, by the authorization engine, to the issuing processor, the authorization status. In the example method, further comprising: updating a transaction record with the authorization status. In the example method, the comparing, by the authorization engine, the transaction data to the rule data comprises comparing each value of the set of one or more values of the one or more attribute fields to corresponding attribute data of the transaction data to determine whether a match occurs. In the example method, the expiration value is one of: a point in time, a time period, or a duration. In the example method, further comprising: providing a user interface, to a client computing device, for presenting to a user, wherein the user interface is configured to receive and transmit to the authorization engine the rule data. In the example method, a given attribute field of the one or more attribute fields is one of: merchant category code, merchant name, merchant descriptor, merchant currency, merchant address, merchant city, merchant state, merchant postal code, and merchant country. In the example method, monitoring for expiration of the transaction comprises considering the transaction expiration relative to a current time and considering a status of the transaction.

Another example system, including one or more processors; and one or more non-transitory, computer-readable mediums including instructions which, when executed by the one or more processors, cause the system to: receive, at an authorization engine, rule data for defining an expiration for transaction authorizations, the rule data including designation of one or more attribute fields each corresponding to a transaction attribute type from a plurality of transaction attribute types, a set of one or more values for each of the one or more attribute fields, and an expiration value; receive, at the authorization engine, from an issuing processor, over a communication network, a transaction authorization request for a transaction, the transaction authorization request including transaction data; create a transaction data object (e.g., a record, an entity) for the transaction of the transaction authorization request, according to the transaction data; compare, by the authorization engine, the transaction data to an available balance to determine approval of the transaction authorization request and/or determine an authorization status; if the transaction authorization request is approved: compare, by the authorization engine, the transaction data to the rule data to determine whether a match occurs for the transaction data and the rule data; if the match occurs, set a transaction expiration field of the transaction data object to the expiration value; transmit, by the authorization engine, to the issuing processor, an approval message; and transmit, by the authorization engine, the transaction data to a ledger system, wherein the ledger system is configured to update an available balance based on the transaction data, and wherein, if the transaction remains incomplete, the ledger system is configured to reverse the update to available balance, according to the transaction expiration field.

Another example method for configuring transaction authorization expiration, comprising: receiving, at an authorization engine, rule data for defining an expiration for transaction authorizations, the rule data including: designation of one or more attribute fields each corresponding to a transaction attribute type from a plurality of transaction attribute types; a set of one or more values for each of the one or more attribute fields; and an expiration value; receiving, at the authorization engine, from an issuing processor, over a communication network, a transaction authorization request for a transaction, the transaction authorization request including transaction data; comparing, by the authorization engine, the transaction data to an available balance to determine approval of the transaction authorization request and/or to determine an authorization status; if the transaction authorization request is approved: comparing, by the authorization engine, the transaction data to the rule data to determine whether a match occurs for the transaction data and the rule data; if the match occurs, setting a transaction expiration field to the expiration value; transmitting, by the authorization engine, to the issuing processor, an approval message; and transmitting, by the authorization engine, the transaction data to a ledger system, wherein the ledger system is configured to update an available balance based on the transaction data, and wherein, if the transaction remains incomplete, the ledger system is configured to reverse the update to available balance, according to the transaction expiration field.

An example system may include one or more processors, and one or more non-transitory, computer-readable mediums including instructions which, when executed by the one or more processors, cause the system to receive, at an authorization engine, from an issuing processor, a transaction authorization request including transaction information, compare, by the authorization engine, the transaction information to an available balance, based on the comparison, transmit, by the authorization engine, to the issuing processor, an approval message, transmit, by the authorization engine, the transaction information to a line of credit engine, determine, by the line of credit engine, an updated available balance based on the transaction information, and transmit, by the line of credit engine, the updated available balance to the authorization engine.

In the example system, comparing, by the authorization engine, the transaction information to the available balance may include comparing a transaction amount to the available balance. In the example system, determining, by the line of credit engine, the updated available balance may include updating a balance category of the available balance. In the example system determining, by the line of credit engine, the updated available balance may include determining, based on the transaction information, a transaction category corresponding to the balance category. In the example system, the instructions may further cause the at least one of the one or more or more processors to transmit, by the authorization engine, the transaction information to a data enrichment engine, and receive, by the authorization engine, from the data enrichment engine, enriched transaction information, wherein transmitting the transaction information to the line of credit engine may include transmitting the enriched transaction information to the line of credit engine. In the example system, the authorization engine may include a first available balance associated with a first user and a second available balance associated with a second user. In the example system, the line of credit engine may transmit and receive information from the authorization engine using a single communication channel. In the example system, the authorization engine may include a first available balance associated with an available credit amount and a second available balance associated with an available funds amount. In the example system, the instructions may further cause the authorization engine to receive a plurality of transaction authorization requests from a plurality of issuing processors. In the example system, the instructions may further cause the authorization engine to receive updated available balances from a plurality of line of credit engines.

An example method may include receiving, by an authorization engine, from an issuing processor, a transaction authorization request including transaction information, comparing, by the authorization engine, the transaction information to an available balance, based on the comparison, transmitting, by the authorization engine, to the issuing processor, an approval message, transmitting, by the authorization engine, the transaction information to a line of credit engine, determining, by the line of credit engine, an updated available balance based on the transaction information, and transmitting, by the line of credit engine, the updated available balance to the authorization engine.

In the example method, comparing, by the authorization engine, the transaction information to the available balance may include comparing a transaction amount to the available balance. In the example method, comparing, by the authorization engine, the transaction information to the available balance may include comparing a transaction amount to a balance category of the available balance. In the example method, comparing, by the authorization engine, the transaction amount to a balance category of the available balance may include determining, based on the transaction information, a transaction category corresponding to the balance category. In the example method, the instructions may further cause the at least one of the one or more or more processors to transmit, by the authorization engine, the transaction information to a data enrichment engine, and receive, by the authorization engine, from the data enrichment engine, enriched transaction information, wherein transmitting the transaction information to the line of credit engine may include transmitting the enriched transaction information to the line of credit engine. In the example method, the authorization engine may include a first available balance associated with a first user and a second available balance associated with a second user. In the example method, the line of credit engine may transmit and receive information from the authorization engine using a single communication channel. In the example method, the authorization engine may include a first available balance associated with an available credit amount and a second available balance associated with an available funds amount. In the example method, the instructions may further cause the authorization engine to receive a plurality of transaction authorization requests from a plurality of issuing processors. In the example method, the instructions may further cause the authorization engine to receive updated available balances from a plurality of line of credit engines.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented and/or arranged in combination in a single implementation. Conversely, various features that are described in the context of a single implementation can also be implemented and arranged in multiple implementations separately or in any suitable sub combination. Moreover, although features may be described above as acting in certain combinations and even initially claimed as such, one or more features from a claimed combination can in some cases be excised from the combination, and the claimed combination may be directed to a subcombination or variation of a subcombination.

Additionally, features described with respect to particular headings may be utilized with respect to and/or in combination with illustrative implementations described under other headings; headings, where provided, are included solely for the purpose of readability, and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims may be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Having now described some illustrative implementations, implementations, illustrative embodiments, and embodiments, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations, arrangements, elements, or acts of the systems and methods herein referred to in the singular may also embrace implementations including a plurality of these elements, and any references in plural to any implementation, arrangement, element, or act herein may also embrace implementations including only a single element. References in the singular or plural form are not intended to limit the presently disclosed systems or methods, or their components, acts, or elements to single or plural configurations. References to any act or element being based on any information, act, or element may include implementations where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description, or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

It should be understood that no claim element herein is to be construed under the provisions of 35 U.S.C. § 112 (f) unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components, including, but not limited to, processing circuitry, network interfaces, peripheral devices, input devices, output devices, and sensors. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor. In some embodiments, the one or more processors may be external to the apparatus, for example the one or more processors may be a remote processor (e.g., a cloud based processor). Alternatively, or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps, and decision steps.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

The term “coupled” and variations thereof includes the joining of two members directly or indirectly to one another. The term “electrically coupled” and variations thereof includes the joining of two members directly or indirectly to one another through conductive materials (e.g., metal or copper traces). Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical (e.g., magnetic), or fluidic.

What is claimed is:

1. A system comprising:
one or more processors; and
one or more non-transitory, computer-readable mediums including instructions which, when executed by the one or more processors, cause the system to:
receive, at an authorization engine, rule data for defining an expiration for transaction authorizations, the rule data including an expiration value and one or more attribute field-value pairs;
receive, at the authorization engine, from an issuing processor, over a communication network, a transaction authorization request for a transaction, the transaction authorization request including transaction data;
if the transaction authorization request is approved:
compare, by the authorization engine, the transaction data to the rule data to determine whether a match occurs for the transaction data and the rule data;
if the match occurs, set the transaction authorization to expire according to the expiration value;
transmit, by the authorization engine, the transaction data to a ledger system, wherein the ledger system is configured to update an available balance based on the transaction data;
monitor for expiration of the transaction authorization according to the transaction expiration; and
transmit, by the authorization engine, an indication of expiration of the transaction authorization to the ledger system, wherein, the ledger system is configured to reverse the update to available balance, according to the transaction expiration.

2. The system of claim 1, further comprising instructions which, when executed by the one or more processors, cause the system to:
receive, from the ledger system, the updated available balance; and
receive, from the ledger system, the available balance with the update reversed.

3. The system of claim 1, further comprising instructions which, when executed by the one or more processors, cause the system to:
receive at the authorization engine, over a communication network, a default expiration value; and
if the match fails to occur, set a transaction authorization expiration to the default expiration value.

4. The system of claim 1, wherein the rule data further includes one or more of set logic and Boolean logic for combining attribute field-value pairs,
wherein the comparing the transaction data to the rule data to determine whether a match occurs is according to the one or more of the set logic and Boolean logic.

5. The system of claim 1, further comprising instructions which, when executed by the one or more processors, cause the system to:
compare, by the authorization engine, the transaction data to an available balance to determine an authorization status; and
transmit, by the authorization engine, to the issuing processor, the authorization status.

6. The system of claim 1, wherein the comparing, by the authorization engine, the transaction data to the rule data comprises comparing each value of the set of one or more values of the one or more attribute fields to corresponding attribute data of the transaction data to determine whether a match occurs.

7. The system of claim 1, wherein the expiration value is one of: a point in time, a time period, or a duration.

8. The system of claim 1, further comprising instructions which, when executed by the one or more processors, cause the system to provide a user interface to a client computing device, for presenting to a user, the user interface to receive and transmit to the authorization engine the rule data.

9. The system of claim 1, wherein the attribute field-value pairs each comprise an attribute field and a set of one or more values that correspond to the attribute field.

10. The system of claim 1, wherein monitoring for expiration of the transaction comprises considering the transaction expiration relative to a current time and considering a status of the transaction.

11. A method for configuring transaction authorization expiration, comprising:
receiving, at an authorization engine, rule data for defining an expiration for transaction authorizations, the rule data including one or more attribute fields, a set of one or more values for each of the one or more attribute fields, and an expiration value;
receiving, at the authorization engine, from an issuing processor, over a communication network, a transaction authorization request for a transaction, the transaction authorization request including transaction data;
if the transaction authorization request is approved:
comparing, by the authorization engine, the transaction data to the rule data to determine whether a match occurs for the transaction data and the rule data;
if there is a match, setting a transaction authorization expiration to the expiration value;
transmitting, by the authorization engine, the transaction data to a ledger system, wherein the ledger system is configured to update an available balance based on the transaction data;
if the transaction remains pending at a current time corresponding to the transaction authorization expiration, effecting, by the authorization engine, expiration of the transaction authorization;
transmitting, by the authorization engine, in indication of expiration of the transaction authorization to the ledger system, wherein the ledger system is configured to reverse the update to the available balance, according to the transaction authorization expiration.

12. The method of claim 11, further comprising:
receiving, at the authorization engine, the updated available balance; and
receiving, at the authorization engine, the available balance with the update reversed.

13. The method of claim 11, further comprising:
receiving, at the authorization engine, a default expiration value; and
if the match does not occur, setting, by the authorization engine, a transaction expiration to the default expiration value.

14. The method of claim 11, wherein the rule data further includes one or more of set logic and Boolean logic for combining two or more of the attribute fields of the one or more attribute fields,
wherein the comparing the transaction data to the rule data to determine whether a match occurs is according to the one or more of the set logic and Boolean logic.

15. The method of claim 11, further comprising:
comparing, by the authorization engine, the transaction data to an available balance to determine an authorization status; and
transmit, by the authorization engine, to the issuing processor, the authorization status.

16. The method of claim 11, wherein the comparing, by the authorization engine, the transaction data to the rule data comprises comparing each value of the set of one or more values of the one or more attribute fields to corresponding attribute data of the transaction data to determine whether a match occurs.

17. The method of claim 11, wherein the expiration value is one of: a point in time, a time period, or a duration.

18. The method of claim 11, further comprising:
providing a user interface, to a client computing device, for presenting to a user, wherein the user interface is configured to receive and transmit to the authorization engine the rule data.

19. The method of claim 11, wherein a given attribute field of the one or more attribute fields is one of: merchant category code, merchant name, merchant descriptor, merchant currency, merchant address, merchant city, merchant state, merchant postal code, and merchant country.

20. The method of claim 11, wherein monitoring for expiration of the transaction comprises considering the transaction expiration relative to a current time and considering a status of the transaction.
